(19) United States
(12) Patent Application Publication
(10) Pub. No.: US 2009/0300174 A1
(43) Pub. Date: Dec. 3, 2009

(54) SPACE MANAGEMENT SYSTEM AND METHOD

(75) Inventors: Daniel Benvenuto Floris, Oxford (GB); Marie-Cecile Puybaraud, Tourtoirae (FR)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 12/397,143

(22) Filed: Mar. 3, 2009

Related U.S. Application Data
(63) Continuation of application No. PCT/US2007/077658, filed on Sep. 5, 2007.
(60) Provisional application No. 60/842,545, filed on Sep. 6, 2006.

(51) Int. Cl. G06F 15/173; G06F 3/048

(52) U.S. Cl. 709/224; 715/764

(57) ABSTRACT

A space management system for analyzing the utilization of a space by one or more persons is provided. The space management system includes a data collector configured to collect information output by an identifier distributed in or around the space. The information indicates presence of the one or more persons in the space. The data collector is further configured to store occupancy data for the space based on the collected information. A data analyzer coupled to the data collector is configured to generate a graphical report or user interface based on the occupancy data.

### CROSS-REFERENCE TO RELATED APPLICATIONS

The present application is a continuation of International Application No. PCT/US2007/077658, filed Sep. 5, 2007, which claims the benefit of U.S. Provisional Application No. 60/842,545, filed Sep. 6, 2006, both of which are incorporated herein by reference in their entireties.

### BACKGROUND

The present invention relates to space management systems and methods.

A conventional workplace utilization system and method has been performed by use of a manual clipboard that a monitor uses to write down a utilization of spaces and to manually create a printed report.

### SUMMARY

One embodiment relates to a space management system for analyzing the utilization of a space by one or more persons. The space management system includes a data collector configured to collect information output by an identifier distributed in or around the space. The information indicates presence of the one or more persons in the space. The data collector is further configured to store occupancy data for the space based on the collected information. A data analyzer coupled to the data collector is configured to generate a graphical report or user interface based on the occupancy data. The graphical report or user interface displays an indication of a percentage of time the space was occupied during a period of time and/or a graphical indicator based on the percentage of time the space was occupied during the period of time and the number of persons present in the space during the period of time.

Another embodiment relates to a space management method for a plurality of spaces. The method utilizes a plurality of identifiers configured to receive information output by a plurality of identification devices. The information relates to the presence of a respective identification device in a respective space. The space management method includes collecting the information and storing the information as occupancy data. The space management method further includes analyzing the occupancy data to generate a report or a user interface showing the results of the analysis. The report or user interface is based on a percentage of time each space was occupied during a period of time, and/or the percentage of time each space was occupied during the period of time and the number of persons present in each space.

Alternative exemplary embodiments relate to other features and combinations of features as may be generally recited in the claims.

### BRIEF DESCRIPTION OF THE FIGURES

The application will become more fully understood from the following detailed description, taken in conjunction with the accompanying figures, wherein like reference numerals refer to like elements, in which:

FIG. 1 is a perspective view of a workplace that may use a space management system or method, according to an exemplary embodiment;

FIGS. 2A and 2B show elements of a space management system according to an exemplary embodiment;

FIG. 3 shows a possible implementation of a graphical user interface that may be utilized in a space management system, according to an exemplary embodiment;

FIG. 4 shows a possible implementation of a graphical user interface that may be utilized in a workplace booking tool according to an exemplary embodiment;

FIG. 5 shows a possible implementation of a graphical user interface that may be utilized in a utilization grid analysis according to an exemplary embodiment;

FIG. 6 shows steps involved in a space management method according to an exemplary embodiment;

FIG. 7 shows an interface of a space management system according to an exemplary embodiment;

FIG. 8 shows a view of a “space” interface of a space management system, according to an exemplary embodiment;

FIG. 9 shows an interface of a space management system with “space status” selected, according to an exemplary embodiment;

FIG. 10 shows an interface of a space management system with “chargeback type” selected, according to an exemplary embodiment;

FIG. 11 shows an interface of a space management system with “space category” selected, according to an exemplary embodiment;

FIG. 12 shows an interface of a space management system with “space type” selected, according to an exemplary embodiment;

FIG. 13 shows an interface of a space management system with “business unit” selected, according to an exemplary embodiment;

FIG. 14 shows an interface of a space management system with “department” selected, according to an exemplary embodiment;

FIG. 15 shows an interface of a space management system with “space type” and “modify data” selected, according to an exemplary embodiment;

FIG. 16 shows an interface of a space management system with a pop-up window appearing based on selection of “modify data”, according to an exemplary embodiment;

FIG. 17 shows an interface of a space management system selected in the “chargeback type” mode selecting “reports” on the toolbar of the opening page, according to an exemplary embodiment;

FIG. 18 shows an interface of a space management system with “summary reports” selected in the “space type” mode, according to an exemplary embodiment;

FIG. 19 shows an interface of a space management system showing an organizational breakdown report selecting “reports” on the toolbar of the opening page, according to an exemplary embodiment;

FIG. 20 shows an interface of a space management system showing a live tracking grid, according to an exemplary embodiment;

FIG. 21 shows an interface of a space management system showing a utilization grid, according to an exemplary embodiment;

FIG. 22 shows an interface of a space management system showing a utilization summary report, according to an exemplary embodiment;

FIGS. 23A through 23E show examples of reports generated by the space management system, according to an exemplary embodiment;

FIGS. 24A through 24D show screenshots of a method of accessing reporting tools of or associated with the space management system, according to an exemplary embodiment;

FIGS. 25A and 25B show pages of occupancy reports from the reporting tools of the space management system, according to an exemplary embodiment;

FIGS. 26A and 26B show more pages of occupancy reports from the reporting tools of the space management system, according to an exemplary embodiment;

FIG. 27 shows reports in a spreadsheet format generated from the reporting tools of the space management system, according to an exemplary embodiment;

FIG. 28 shows a page of the space management system showing a booking tool that is provided when a user selects “tools” on the space management system's toolbar, according to an exemplary embodiment; and

FIG. 29 shows a page of the space management system showing a workstation floor plan in the booking tool mode, according to an exemplary embodiment.

### DETAILED DESCRIPTION OF THE EXEMPLARY EMBODIMENTS

Before turning to the figures which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting.

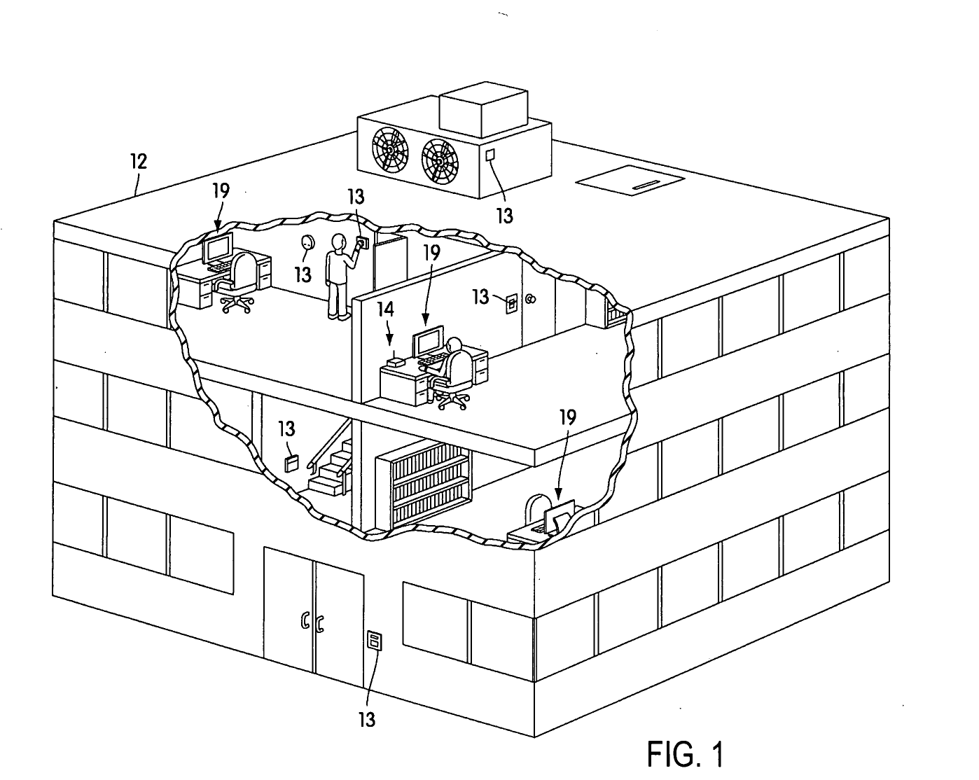

FIG. 1 is a perspective view of a workplace 12 having a plurality of devices or sensors 13 capable of transmitting and/or receiving signals in various ways (e.g. via radio frequency), according to an exemplary embodiment. As illustrated, workplace 12 may include any number of floors, rooms, facility areas, and/or other building structures. According to various exemplary embodiments, workplace 12 may be any area of any size or type, including an outdoor area. Devices 13 may exist inside or outside of the facility, on walls or on desks, be user interactive or not, and may be any type of building management device. For example, devices 13 are illustrated as a security device, a light switch, a fan actuator, a temperature sensor, a thermostat, a smoke detector, etc. Devices 13 may also include a heat sensor or a motion detector sensor designed to monitor occupancy of various workstations 19 or other areas of workplace 12. Wireless device 14 may be a sensing wireless node. Workstations 19 are shown as personal workstations. Devices 13 may conduct building management functions (e.g., temperature sensing, security functions, fire alarm functions, etc.) in addition to measuring or sensing other devices or objects in the environment of workplace 12. Wireless device 14 may serve as a network coordinator and/or recipient of the data collected by devices 13. Wireless device 14 may be communicably coupled (e.g., via a wired or wireless network connection) to workstations 19. Devices 13 and wireless device 14 may be identifiers as later described and shown in subsequent figures. Wireless device 14 may be located on or under a desk to identify an identification device worn or carried by a user of the desk. Locating an identifier under a desk may help provide detailed and/or highly accurate information regarding whether the desk is occupied.

According to an exemplary embodiment, there is provided a space management system that is configured to monitor space information. The space management system may use the space information to efficiently manage space in a workplace. Spaces may be defined by type, category, chargeback and/or corporate level. A space may correspond to a workstation, a meeting room, an office, a open area and/or any other grouping or collection of facility space. A booking unit may provide an on-line booking system for allowing a person to conveniently book, reserve or schedule a workstation, a desk and/or another space for a desired period of time. A display unit communicably coupled to the space management system may display real-time (or near real-time, or historical) occupancy data. The space management system may be capable of detecting, tracking, and/or archiving human presence. The system may obtain information from an identification device, such as a wireless Radio Frequency Identification (RFID) tag, to capture occupancy data. An exemplary embodiment provides a user with accurate space utilization data so that the user can make a performance measurement that can lead to improved specifications for the workplace.

The systems and methods described below may be implemented in an automated or nearly automated systems or collection of systems which may allow for real-time or near real-time updates to be performed by the systems and methods. It is understood that the various systems and methods described below may be executed in real-time, near real-time, rapidly, on an on-demand basis, on a scheduled basis or otherwise.

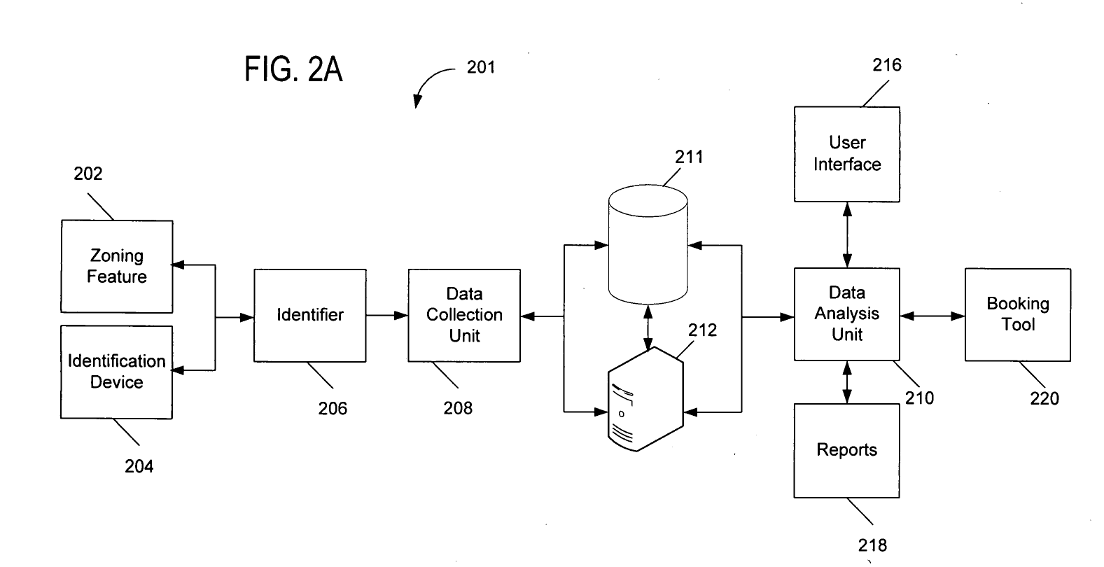

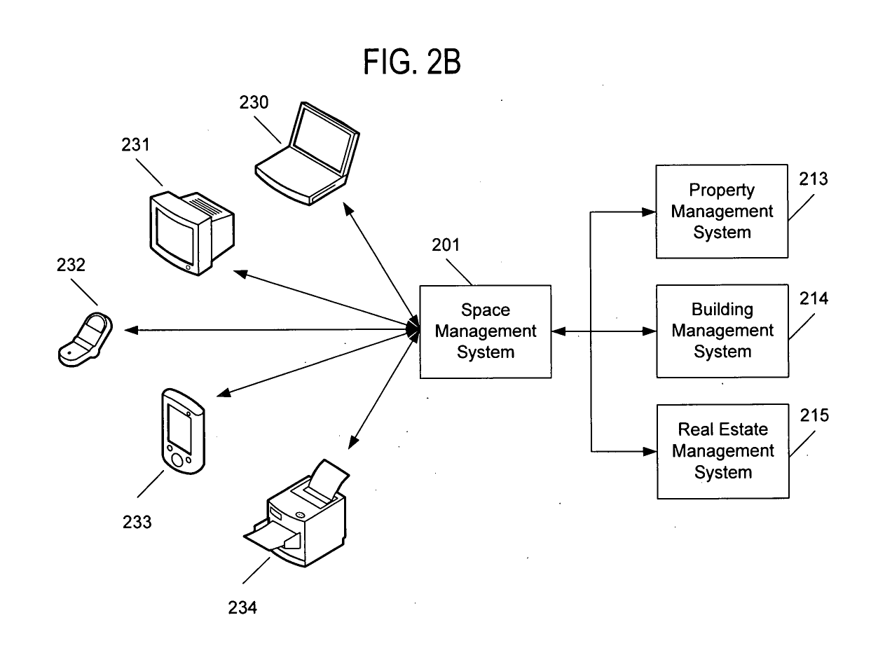

Referring now to FIG. 2A, an exemplary embodiment of a space management system 201 includes zoning feature 202 in which a workplace is divided into a plurality of spaces, whereby the size and number of spaces is decided by the person implementing the system or via an automated method. For example, an office may be divided into a plurality of spaces, whereby a space may correspond to a workstation, a meeting room, or an open space (e.g., a shared space, a cubicle, etc.). An identification device, such as a RFID tag, may be provided to people, objects, or assets. For example, everyone working in the area to be monitored by the space utilization system may be provided with identification device 204. Identification device 204 may be carried on a person's body (e.g., clips onto a shirt or belt). Identification device 204 could be anonymous or could be clearly identifiable (e.g., name, post, age, department, etc.) in that it does not have to identify the person, object or asset identification device 204 is associated with, but rather just provides an indication that identification device 204 (and thus the person wearing identification device 204) is currently located at or around a particular space (when read by the identifier in that space). Identification device 204 may be provided as a chip embedded on an employee badge, for example.

Identification device 204 may have a unique identification (ID) number associated with it in order to distinguish it from other identification devices worn by other users. Identification device 204 may be configured to identify which department the person or object wearing identification device 204 belongs to. For example, according to an exemplary embodiment, identification device 204 may help differentiate between departments, such as a finance department (e.g., all identification devices having an ID starting with the number 1, such as 100, 101, 102, etc.), a human resources department (e.g., all identification devices having an ID starting with the number 2, such as 200, 201, 202, etc.), a system and services department (e.g., all identification devices having an ID starting with the number 3, such as 300, 301, 302, etc.), etc. If chosen, the actual person wearing identification device 204 could not be identifiable by way of the information output by identification device 204 and read by a particular identifier in a particular space.

According to an exemplary embodiment, identification device 204 may be a RFID tag. The wearing of RFID tags 204 may be optional.

As described above, each space is provided with an identifier 206, for example, a RFID tag reader. While identifier 206 is an RFID tag reader according to a preferred embodiment, any number of present or future technologies could be used to detect identification devices and/or people or assets. For example, identifier 206 and/or identification device 206 may be a global positioning satellite (GPS) device, an ultra-wide band device, a ZigBee® device, a mobile phone or a device configured to detect or communicate with mobile phones, a computing device, a personal digital assistant (PDA), a digital and/or analog video camera, a WiFi-enabled device, a Bluetooth®-compatible device, etc. When a person, object or asset enters a space, identification device 204 worn by the person, or carried on the object or asset is detected by identifier 206 provided in that space. Identifiers 206 may be positioned under a desk in the space or in the middle of a meeting room (for a space that consists of a meeting room) or in the middle of an open space (for a space that consists of an open space) or at the entrance of a room (for a space which does not allow positioning in the middle of the space) or be provided at any location in a space. Identifier 206 may be plugged into a main power supply (12V or 24V). Identifier 206 may also be battery powered or self powered. In one possible implementation, identification devices 204 and identifiers 206 may be RFID tags and RFID tag readers manufactured by Scemtec Transponder Technology, GmbH. Of course, identification devices 204 and identifiers 206 made by other manufacturers may be utilized.

The information read by each identifier 206 in the system is sent to data collection unit 208, by wireless and/or wired communications. Data collection unit 208 may include a receiver for receiving the data from identifiers 206 and a storage unit (e.g., a database) for storing the received data. Data collection unit 208 may be provided at a server which stores or is communicably coupled to a database or on another server on a network. Data collection unit 208 may be various types or collections of systems, databases, servers, and/or networks.

According to one exemplary embodiment, data collection unit 208 may include or be communicably coupled to database 211. Database 211 receives data from identifiers 206 and stores the data for data analysis unit 210 to use. According to another exemplary embodiment, database 211 may be associated with a SQL server, a database management system, or any other type of database that can be queried to obtain information stored therein.

After the data is received and stored, the data is analyzed by data analysis unit 210. Data analysis unit 210, data collection unit 208, and database 211 may each exist as software modules, routines, and/or data stores of server 212. According to other exemplary embodiments, data collection unit 208, data analysis unit 210, and/or database 211 may exist on separate servers or distributed servers. Data analysis unit 210 may be located on the same network as server 212 and database 211 and/or be accessible by the rest of space management system 201 via the Internet.

The data is interpreted in a utilization grid and various occupancy and utilization reports that provides a percentage of time the space is occupied and the occupancy percentage (e.g., 25% occupied, 75% occupied with respect to maximum occupancy amount). The data collected about space utilization could be anonymous in that the actual identity of persons in any one space could remain unknown.

Referring to FIGS. 2A and 2B, space management system 201 may also include or be coupled to property management system 213, according to another exemplary embodiment. Property management system 213 receives data from identifier 206 and may helps data analysis unit 210 determine a proper breakdown or adjustment of usage. Property management system 213 may also use data residing in data collection unit 208 or database 211 to schedule property management tasks, bill property management clients, forecast or estimate property management expenses (e.g., property that is highly utilizes will likely require higher than average property management expenses, etc.). Building management system (BMS) 214 may also be communicably coupled to data collection unit 208 and/or another component of space management system 201. Building management system 214 may provide input for report generation and reporting. The space management system may also be implemented as a module or software component of a building management system 214. Real estate management system 215 may also be communicably coupled to data collection unit 208, according to another exemplary embodiment. Real estate management system 215 may use the data of the space management system to determine a optimal ways to manage space, to identify unused space, to identify space that is utilized heavily and may be rented at a higher rate, etc. Real estate management system 215 may be a real estate management system such as Sequentra® sold by USI Companies, Inc.

An exemplary embodiment provides for automatic live data collection, nearly instant occupancy results, direct data visualization, a graphical user interface to allow a data analyzer to filter and easily interpret the data, accurate monitoring, and is an easily redeployable system (e.g., move an identifier to a different location to change a space to a new location, or add an identifier to a location to add a new space to a region being monitored). Space management system 201 may provide user interfaces and/or reports to a variety of end-user devices via an Internet, LAN, WAN, or other network. These devices may include, for example, laptop or computing device 230, display 231, mobile phone 232, personal digital assistant 233, and/or printer 234.

User interface 216 may be coupled to data analysis unit 210. User interface 216 may be a web-based user interface and provide users with a decision-making tool that enables the identification of possible space utilization issues and solutions. Space management system 201 may thereby help users rapidly create an optimal workplace environment or troubleshoot a troubled environment. User interface 216 may be implemented as a web-based application, whereby information sent from the identifiers to the data collection unit, and/or analyzed by data analysis unit 210 is viewable via the Internet, for example, or by a local area network (LAN) or a wide area network (WAN). According to various alternative embodiments, the space management system is not a web-based system but is a standalone or networked application.

Space management system 201 may include a booking tool 220, according to an exemplary embodiment. Booking tool 220 (e.g., workstation booking tool, conference room booking tool, space booking tool, etc.) may be a web-based software module or routine(s) that supports business flexibility and high workforce mobility by allowing workspaces to be analyzed and booked via a graphical user interface coupled to near live utilization data. Booking tool 220 allows workstations to be shared according to demand. Workstations can be booked online (bookings may be scheduled in advance). Booking tool 220 may be simple to use. Using booking tool 220, a workstation can be booked quickly, such as by just three clicks of a mouse. Little training may be required to operate this tool. Booking tool 220 can also be configured to monitor space usage and support the development and execution of an appropriate workplace strategy. Growth can be more readily accommodated by using booking tool 220, as long-term space commitments may be minimized and conflicts may be identified in advance.

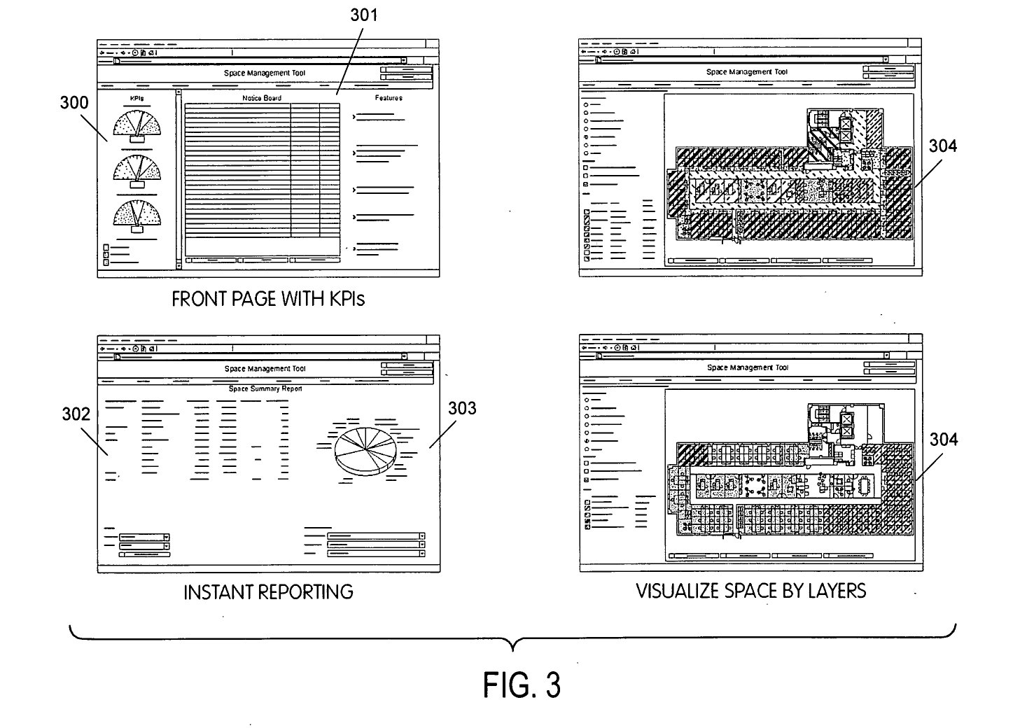

Various types of graphical user interface (GUI) screens may be provided via data analysis unit 210 and user interface 216. Four possible GUI screens are shown in FIG. 3. A front page or other screen may show Key Performance Indicators (KPIs) 300. Key Performance Indicators may display a graphical representation of space utilization by capacity (e.g., 50% utilized) or by headcount (e.g., 10 persons are currently in a space sized for 21 persons). According to an exemplary embodiment, the utilization amount is shown as an arrow on a dial. Notice board 301 may also be provided on the front page or other screen to indicate notices for changes in workplace utilization, such as “Add new workstation to Space #3”, or “Modify Space #2 to include Room #131”, etc. These notices may be manually entered by a user or the system could generate notices or messages based on collected and analyzed utilization data.

Space management system 201 may be configured to generate space summary report 302. Space summary report 302 may display the total area (in square meters or square feet, for example) as a column in the table for each space, a utilization percentage in another column in the table for each space (e.g., 25% occupied), a headcount in yet another column in the table for each space, a space type that identifies the type of each space (e.g., auxiliary space, core space, meeting room, desk, storage space, service space, departmental space), and a space category that identifies the category of each space (e.g., auxiliary, core, office, utility). Other reporting formats could display or show the information of space summary report 302 in different formats. For example, bar chart or pie chart 303 may be included to graphically display records collected for each space. Pull down menus may be included to allow a user to choose a different or desired type of chart to view and to select various different types of data groupings.

Visual space utilization map 304 may also be provided. Visual space utilization map 304 may visually display a map of one or more spaces and the amount of utilization in each of the one or more spaces. Visual space utilization map 304 may allow a user to visualize spaces by layers. Visual space utilization map 304 may by default show the actual disposition of each space in a building, with colors provided for each space to indicate the amount of utilization. The user may be able to select the type of highlights to be provided on the display, whereby highlights can be made by space status, chargeback type, space category, space type, organization level, and/or any other type, level, or category. These selected highlights can be added to the map or removed from the map in layers and in near-real time so that a user may visualize the relationship between types, categories or levels.

Using visual space utilization map 304, a user may also select one space or a group of spaces from the map by, for example, clicking on the desired space, in order to obtain space occupancy data from those one or more spaces. The method of visualization of the occupancy data is also selectable by the user, or the system to match the data. The data may be shown via a table, a pie chart, a bar chart, a building grid showing utilization via color codes, etc.

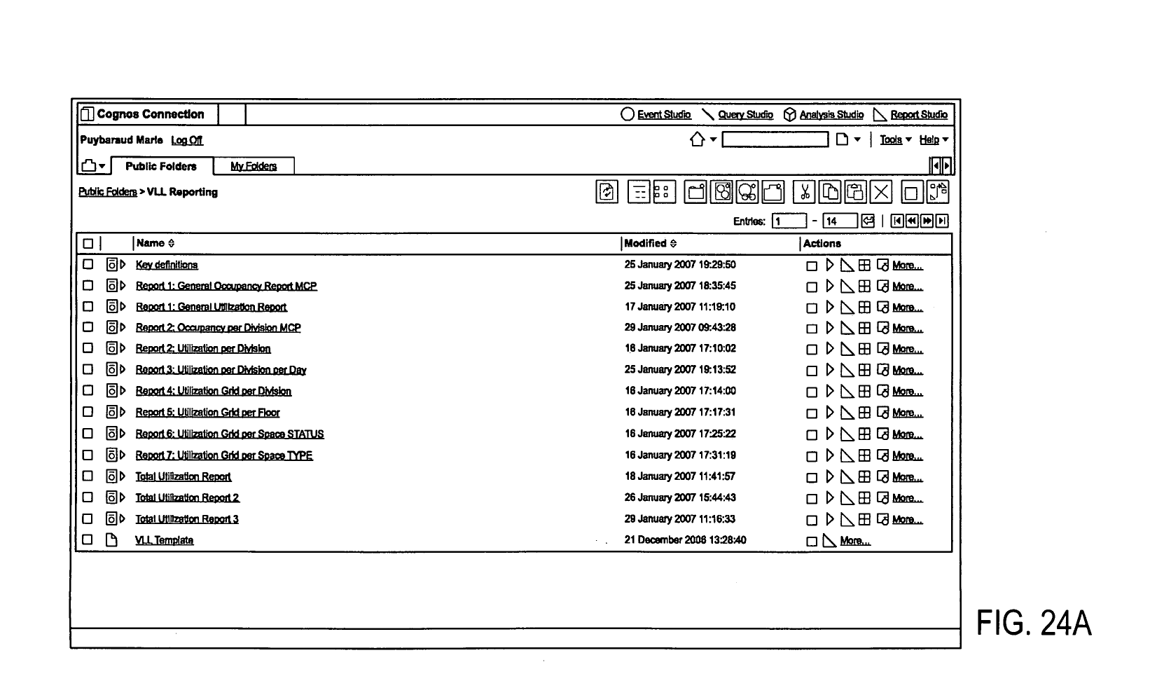

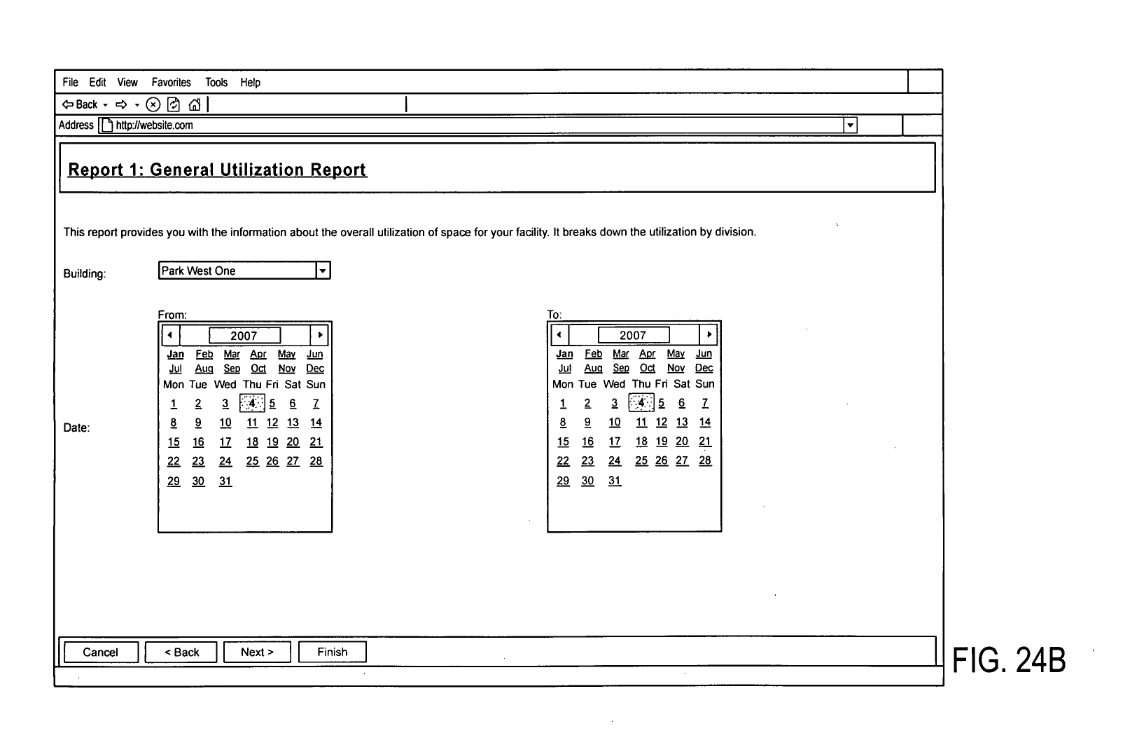

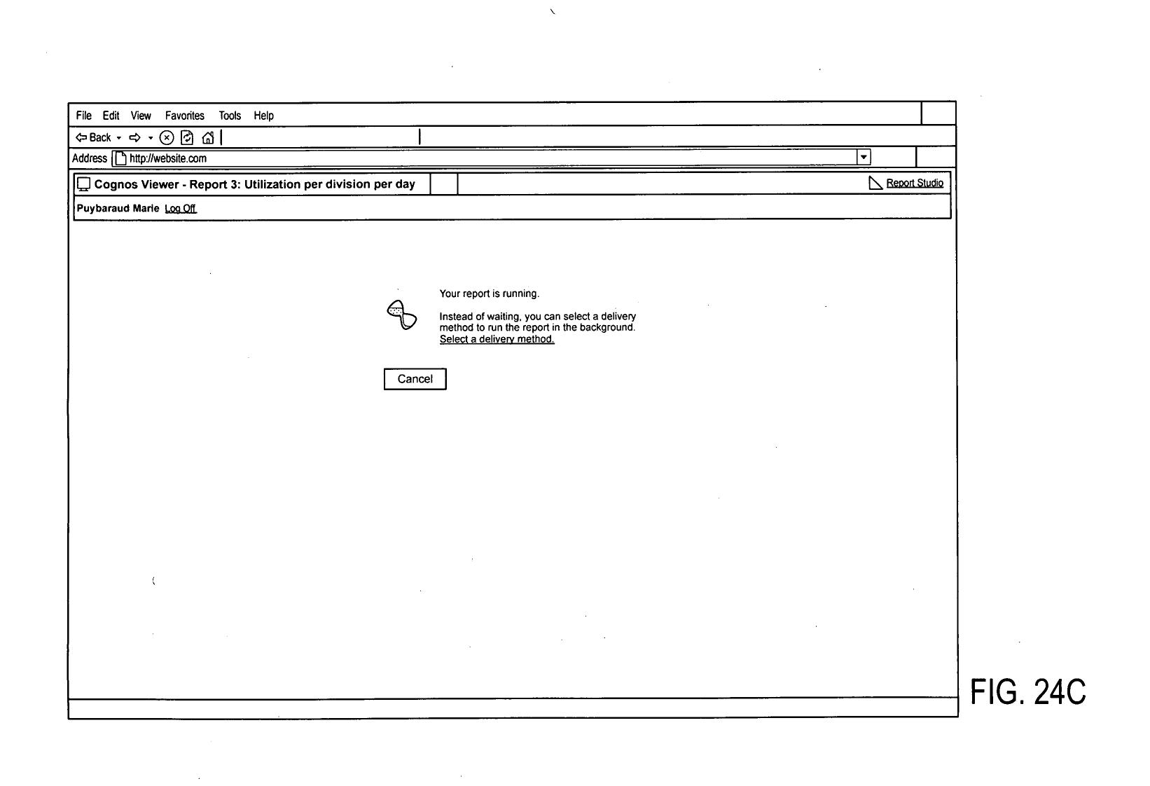

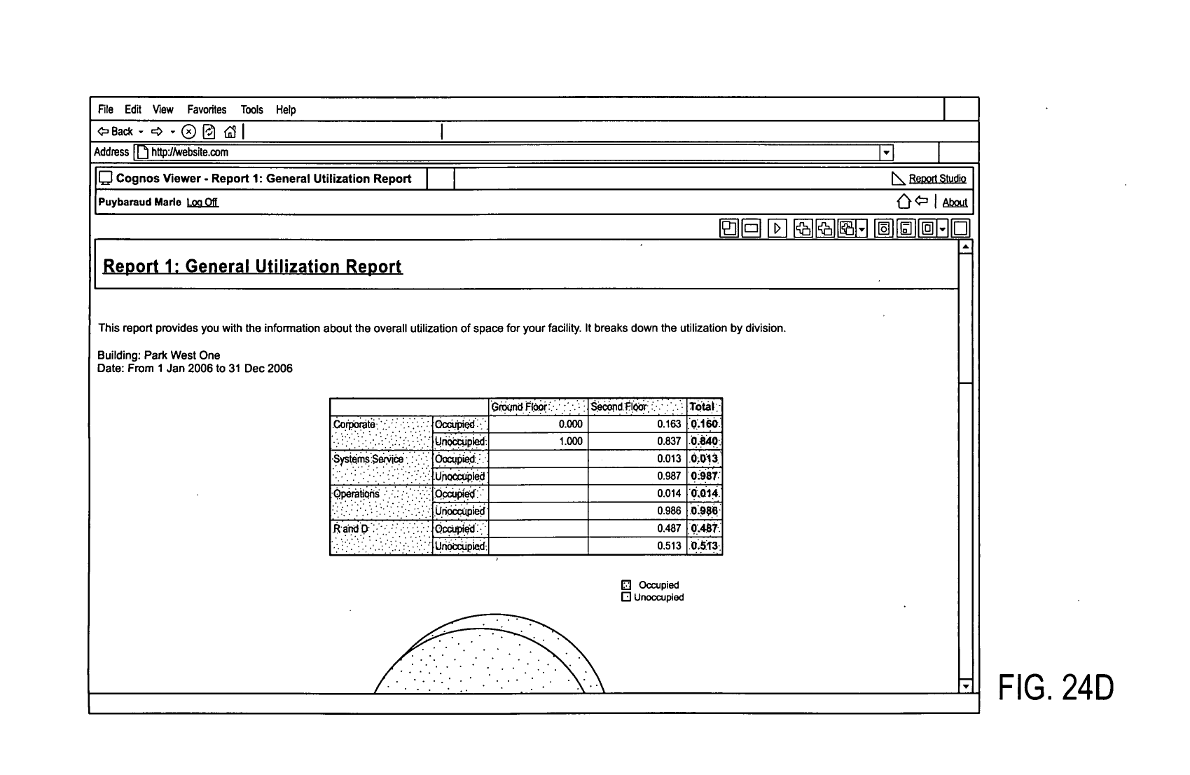

Referring back to FIG. 2A, space management system 201 may generate reports 218 via data analysis unit 210 or otherwise. Reports 218 may include reports relating to occupancy and utilization. Referring again to FIG. 3 and/or FIG. 24A, the user is able to select out of a list of pre-designed reports or to create a new report to analyze the data collected. Reports 218 may allow a very detailed view or visual analysis of the data collected and/or analyzed. For example, a report may be generated that displays the data, tables, and/or summary information behind the graphics displays (bar charts, graphs, tables) showing the occupancy and/or utilization of each space per division, department, space status, space type or space category. Reporting features of the system could be provided via separate software modules, routines, suites, or packages (e.g. a Cognos®, sold by Cognos, Inc., Crystal Reports, etc.).

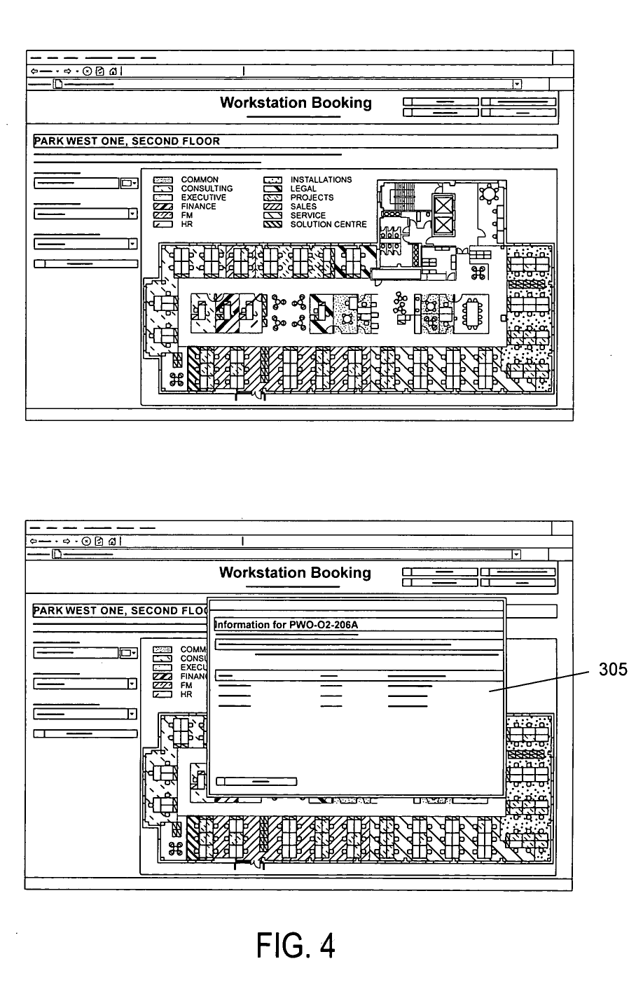

Referring now to FIG. 4, an exemplary user interface for booking tool 220 is shown, according to an exemplary embodiment. The user interface for booking tool 220 may display the locations of the various spaces (e.g., workstations, conference room, shared spaces, etc.) in a building by way of a building grid. Each space may be shown with a particular color associated with the space to indicate the current space type and the department that presently occupies the space (e.g., legal, executive, finance, human resources). A user may be provided with one or more menus to select data relating to booking the space (e.g., which space should be booked, a time of day for which the space should be booked (e.g., from 10 am to 2 pm), and the department for which the user works or for which the space will be used (e.g., legal department), etc.). By selecting the department, booking tool 220 may determine and display which spaces that are allowed to be booked for the department. Once the department selection is made (and/or any other filtering selections are made), booking tool 220 may check a database (e.g., database 211) for available spaces at the particular date and time requested by the user. Booking tool 220 may then provide the user with a booking confirmation or not, depending upon the availability. Booking tool 220 may provide a list of alternative spaces and/or times if the user's first choice is booked. Prior to, during, or after booking, a user can select a particular filter criteria (e.g., department, space type, time, date, utilization percent, etc.), to view presently scheduled bookings and/or space utilization information. The presently scheduled booking or space utilization information may inform the user's booking decision. The viewed bookings or space utilization information may be provided as a separate window 305 on the GUI display, which can be maximized, minimized, or moved to a desired position on the display. According to an exemplary embodiment, a user may filter for a particular space and/or click on a particular space (e.g., building “Park West One”, floor “Second Floor”, and/or space “workstation PWO-02-206A”, etc.) to view detailed information regarding that space (e.g., total capacity, room communication features, etc.).

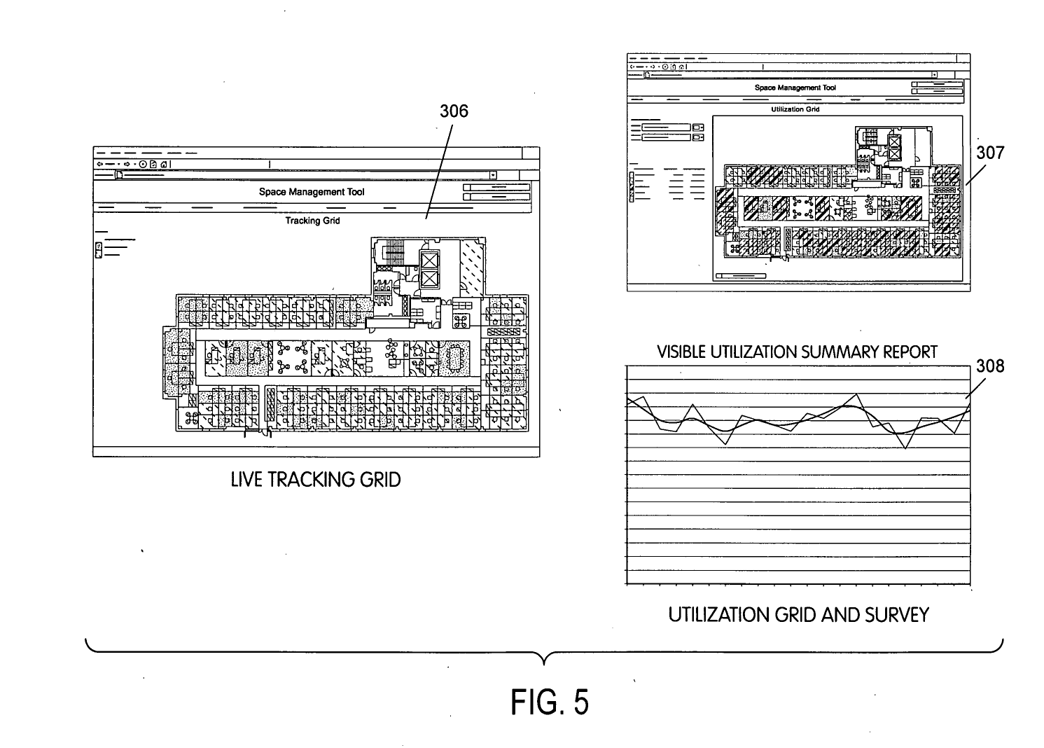

Referring now to FIG. 5, space management system 201 may provide live tracking grid 306 via data analysis unit 210 and user interface 216. Live tracking grid 306 may display a map of a large space or area (e.g., a building floor). The large space or area may be shown broken up into a plurality of smaller spaces (e.g., workstations, conference rooms, shared spaces, etc.). The smaller spaces may be shown via a grid and/or other shapes or lines. The smaller spaces may then be shown with an indication of current or last known utilization. The indication may be shading the smaller spaces with a color, filling the space with a pattern, flashing the space (e.g., if the utilization is particularly high or low), associating an icon to the space, or otherwise. According to a preferred embodiment, the spaces are shown with different colors to indicate utilization. For example, in live tracking grid 306, the color “red” may be used to indicate that a space is occupied with “100% or less utilization”, the color “yellow” may be used to indicate the space is unoccupied with “0% utilization”, the color “green” may be used to indicate 60 to 80% utilization”, the color “blue” may be used to indicate “40 to 60% utilization”, the color “pink” may be used to indicate “20 to 40% utilization”, and the color “white” may be used to indicate “0 to 20% utilization”. Based on live tracking grid 306, a user can make decisions to move personnel from overused spaces to underused spaces. Live tracking grid 306 may also inform a user's activity with respect to booking tool 220. Live tracking grid 306 may be particularly useful in cases where space is overused, as overused spaces tend to be noisier and/or less organized, leading to less productivity in those spaces as compared to lesser used spaces.

Data analysis unit 210 and/or user interface 216 may also generate and display space utilization grid 307. Space utilization grid 307 may display an indication of aggregate utilization of spaces. For example, space utilization grid 307 may display utilization averaged over a period of time (more than one hour, a day, multiple days, the year, etc.), a particular large space (e.g., building/floor/sector) and “date from” to “date to” or “hour from” to “hour to” information. For example, space utilization grid 307 shows utilization in various spaces as “critical low” (Utilization below 15%), “low” (Utilization between 16-40%), “normal” (Utilization between 41-60%), “good” (Utilization between 61-80%), or “critical high” (Utilization above 80%). Utilization levels may be indicated on the displayed grid using different colors to indicate the different utilization levels. The user may decide to modify the utilization scales and/or change the indication methods (e.g., color, crosshatching, icon-based identification, flashing, etc.). Data analysis unit 210 may consider a great number of data points relating to utilization for each space (e.g., every identification device instance detected by the identifier(s) of the relevant spaces during the period selected by the user) to produce the numbers that are used to generate space utilization grid 307. Data analysis unit 210 may average the utilization over a time period or use some other formula or set of formulas to generate the data of space utilization grid 307.

Space management system 201 may generate any number of summary reports 308 via data analysis unit 210. Summary reports 308 may display, for example, the average utilization amount for one or more spaces over a particular time period, such as the last six months. Summary reports 308 may provide valuable information for users making decisions concerning disposition of employees within a building. Summary reports 308 may calculate, identify and/or display peak and off-peak periods of utilization and/or occupancy of the space.

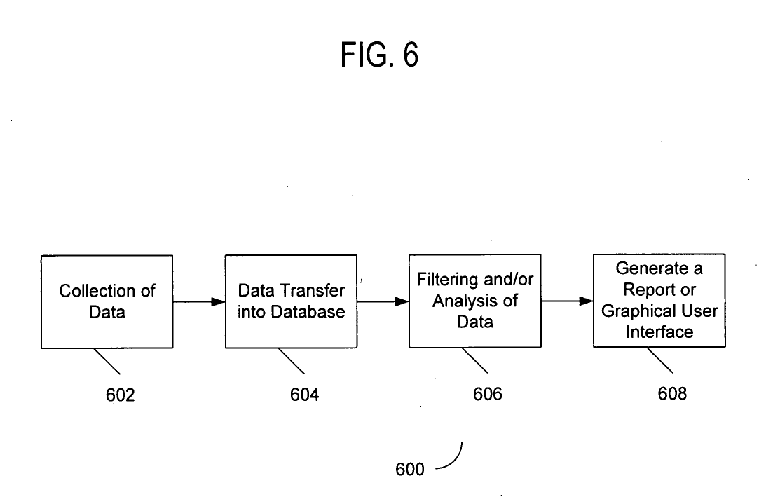

Referring now to FIG. 6, a method 600 of providing space management via a space management system is shown, according to an exemplary embodiment. The method may utilize a plurality of identifiers configured to receive information output by a plurality of identification devices. The information output by the plurality of identification devices relates to the presence (or absence, according to some exemplary embodiments) of a respective identification device in a respective space. The method may include the steps of collecting the information received by the identifiers (step 602). Collecting may be accomplished on a schedule, initiated by the identifiers, initiated by the data collector, initiated by some other space management system component or otherwise. Once the information has been collected, the data collector may transfer the data (step 604) to one or more data stores or databases. During this step, any number of record adds, updates, and/or other tasks to organize the data in a data store or database may take place. The organized and/or stored information may be referred to as occupancy data. Once collected and stored, the occupancy data may be analyzed (step 606). Data analysis may include any processing, querying, transforming, selecting, copying, updating, appending, and/or other routines or steps configured to arrive at data views or query results suitable to provide the user interfaces or reports shown or described in this application. Once the information is analyzed, a report or graphical user interface as described or shown in this application may be generated, displayed, printed, e-mailed, and/or otherwise output (step 608).

A space management system, according to various exemplary embodiments provides increased occupant tracking accuracy and/or space utilization accuracy. A space management system of these embodiments may provide this increased accuracy by using radio frequency identification technology to assess local presence. Tracking features of a space management system may thereby assess local presence and associate the local presence with user information. A space management system, with organized and/or well-distributed identifiers, may be able to track mobile workers highly accurately (e.g., within a few meters or feet). Space management systems of various embodiments may be scalable so that many mobile workers and users wearing identification devices can be tracked simultaneously. This scalability may help ensure that space management services can be applied to an entire working environment.

A space management tool, according to an exemplary embodiment, may integrate location tracking and space management capabilities with facilities management systems or software (e.g., the ARCHIBUS/FM® suite of software sold by Archibus, Inc., METASYS® hardware and software sold by Johnson Controls, Inc., etc.). A space management system may also integrate space management features with computer aided design software and/or hardware (e.g., AutoCAD® sold by Autodesk, Inc.). The level of integration of a space management system with a facilities management system and/or a computer aided design system may vary. For example, some space management systems may be highly integrated in that they are software and/or database modules of the facilities management software. Other space management systems may be loosely integrated and these systems may essentially pass data to and/or from the space management system (or its components) to a facilities management system or computer aided design system.

According to an exemplary embodiment, a facility management system (e.g., ARCHIBUS/FM®) and/or a computer aided design system may provide drawing/graphical information management to a space management system. The space management system may receive inputs of floor graphics, workspace graphics, space coordinates, and/or any other information or data that may enable the space management system to accurately display or generate and display the space or space grid. According to an exemplary embodiment, several modules may plug-in to a facility management system, to provide for a space management system: 1) a space management module—for organizing and analyzing spaces to optimize usage; 2) a furniture and equipment module—to monitor the location and cost of assets, calculate depreciation and plan moves of employees and physical assets; 3) a computer-aided design (e.g., AutoCAD®) module—for the creation of database records and linking them graphically to floor plans using and for providing overlay graphics and design management features for altering space graphics; 4) a strategic planning module—for making informed business decisions about space in the context of organizational growth or contraction; and 5) a telecommunications and cable management module—for creating an inventory and/or views of physical cabling and connectivity in the workplace.

Space management systems of various exemplary embodiments provide flexibility by offering an integrated system that allows accurate monitoring of space (space allocation), mobile workers (people tracking) and/or devices (asset tracking). Monitoring can be accomplished in real time (or near-real time, or historically). Vacant and nearly-vacant spaces can be identified, allowing a manager to redeploy personnel in an efficient manner without overcrowded spaces. A space management system may also provide for easy deployment of business applications, in that, more than a facilities management tool, the space management system may provide a real time occupancy information and tools for analyzing, summarizing, reporting, and using the information. Further, a space management system, according to various exemplary embodiments, may provide for asset tracking, inventory management, location-based security. Space management systems may also be integrated with other business tools (e.g., finance systems and human resources systems such as those sold by ORACLE and SAP).

As stated above, an exemplary embodiment collects live information, stores and/or archives the information, analyzes the information, and generates reports and/or graphical user interfaces. The web-based or networked nature of various embodiments allows analysis to be performed at a location far away from the data collection site. Further, graphical user interfaces of various embodiments allow dynamic updates of space, occupancy, and chargeback data.

A space management system may be utilized to assess space required for present and future demand. Additionally, for companies that are in the business of renting out office space, an exemplary embodiment utilizes the information collected by a data collection unit to allow a company to rent space on a per-use or utilization percentage basis (or to at least analyze their space and/or leases by these types of metrics). Such a feature may be implemented via a tool built into a space management system or by coupling a space management system to a leasing system or software. For companies that rent or own the space in which they conduct their business, various space management system embodiments may provide those companies with interfaces and reports that enable the companies to decide whether or not they have too much, too little, or just the right amount of space to accommodate their workers. For the case where they have too much space, those companies can use space management systems coupled to leasing systems or having built-in leasing tools to sublet out a portion of their workspace.

According to various exemplary embodiments, a space management system may be configured to capture and record human activity, interaction, and presence in a space. The space management system may be communicably coupled to a database that stores space definition information. This space definition information may include, for example, space location, space name, building name, building floor, space type, status chargeback, category, corporate level, number of subspaces, workspaces, or desks, space size, location, department assigned to use the space, the entity paying for the space, cost information, and/or any other information used to identify, describe or define spaces. The space management system may then use one or more identifiers to capture/collect data on the location of people or assets (that may be carrying identification devices) within the space. A data analysis unit may generate user interfaces (e.g., graphical user interfaces) and reports based on the collected data. This data may provides utilization graphs, key performance indicators (KPIs), detailed reports and/or space utilization summaries or reports. These interfaces, summaries, and/or reports may be linked and/or accessible via the Internet (e.g., via a web-based interface). The data source providing space definition information may be a facility management system, building management system, or similar system having information regarding spaces.

A space management system may also receive live information or periodic updates regarding space definition information. This information or these updates may be also be provided via links to facility management systems or building management systems. This information or these updates may also be provided via any number of additional or alternative data sources (e.g., financial software, human resources software, etc.). A space management system may also create or update a database or databases with position information of identification devices in spaces for every polling period (e.g., updated every second). In particular, the space to be surveyed is divided (manually or otherwise) into sub-spaces, whereby each space is equipped with one or more identifiers. An identification device worn by a person (or alternatively, an object or asset) entering a space is detected by the one or more identifiers in that space. This detection information is sent to a database, data collector, or suitable server (e.g., SQL Server). The information is then archived in a database (e.g., utilization grid, table, group of tables, relational database, etc.). The information may then be analyzed by a data analysis unit or queried by a report or user interface. The report, user interface, or data analysis unit may run queries or routines that provide information such as percentage of the time or amount each space is occupied (relative to a maximum occupation time or amount in a space). The data can be shown graphically in different forms as discussed above and below. A booking tool may be use the data to allow a user to book a space. The system may also be used to track people, objects or assets.

The space management system of an exemplary embodiment is configured as a web-based tool which facilitates internet/intranet access to building portfolio space information. As a result, portfolio-wide organization and occupancy information may be maintained, viewable, and manageable online.

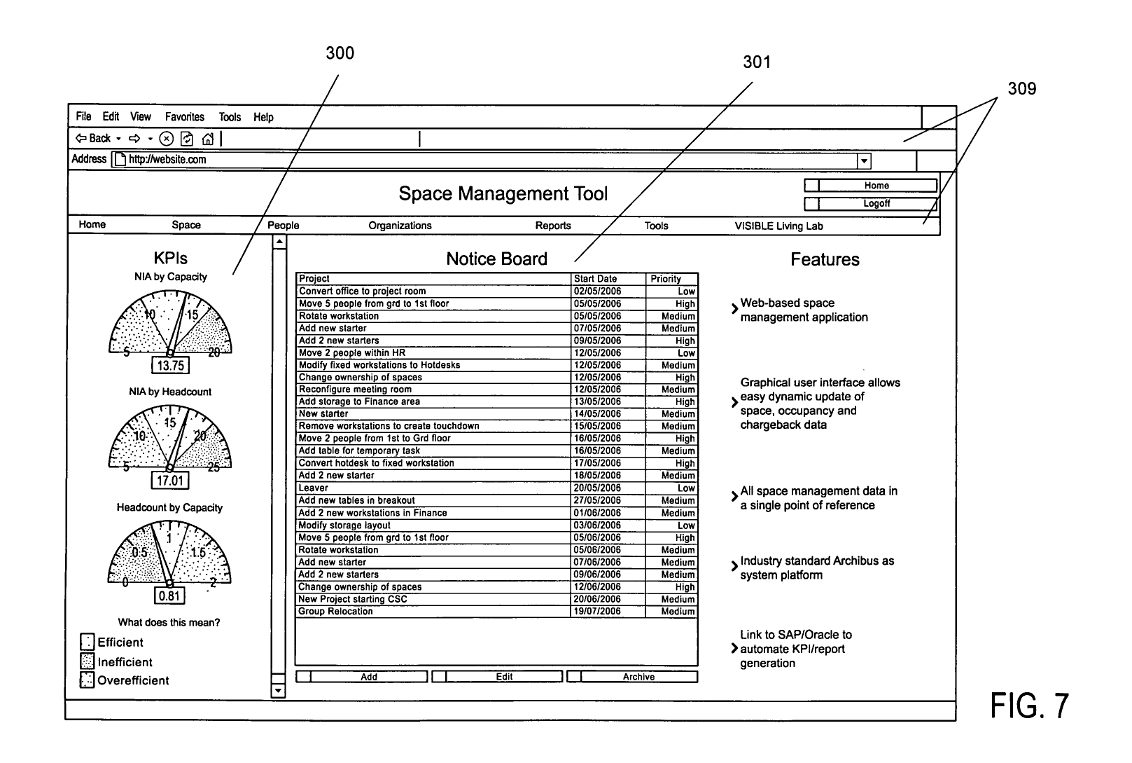

FIG. 7 shows an opening page (or otherwise) of a space management system of an exemplary embodiment, implemented as a Web-based tool, shown as a GUI display. The display includes toolbar and function menus 309, KPIs 300, and notice board 301. Notice board 301 includes notices of all modifications to the system and/or other notices as users may find appropriate to post. For example, users may utilize notice board 301 as a “to do” list, capturing tasks that should be accomplished soon via the space management system or otherwise. KPIs 300 may show a net internal area (“NIA”) by capacity, a net internal area by headcount, a headcount by capacity, and/or a percentage of utilized space or a percentage of occupied space. KPIs 300 may be shown via gauges (or dials) or may be shown by other system or user-selected formats. The page may be configured to show any number of KPIs 300. Toolbar 309 may include choices such as home, space, people, organization, reports, tools or visible living lab (to represent the tracking system or live view). Toolbar 309 can be configured to show or provide all, more or less functionalities as required by the customer. Functions of the space management system may be modular or modular-based. KPI reports may be generated with charts and gauges when this selection is made by the user. KPI gauges 300 are shown having an “efficient” region (e.g., middle region of the gauge), an “inefficient” region (e.g., left region of the gauge), and an “overefficient” region (e.g., right region of the gauge). Other labels, features, notices, or views may be contemplated while remaining within the spirit and scope of the invention.

By using toolbar 309, one can select “space” to access information on a workplace, such as to view building and floor plans, obtain a summary report, a utilization report, or a chargeback report on a particular “space.” One can click “people” on toolbar 309 to access information about people, such as names and departments of employees and current locations of people in a workplace. One can click “organization” on toolbar 309 to access information about the organization, such as data on the organization and reports on the organization. One can click “reports” on toolbar 309 to obtain access to all reports, such as summary reports, utilization reports, chargeback reports and organization breakdown reports. One can click “tools” on toolbar 309 to perform workstation booking and to perform a post occupancy evaluation questionnaire. One can click “Visible Living Lab” on toolbar 309 to obtain access to a “live view”, tracking grid, tracking information, and/or a “live” utilization grid.

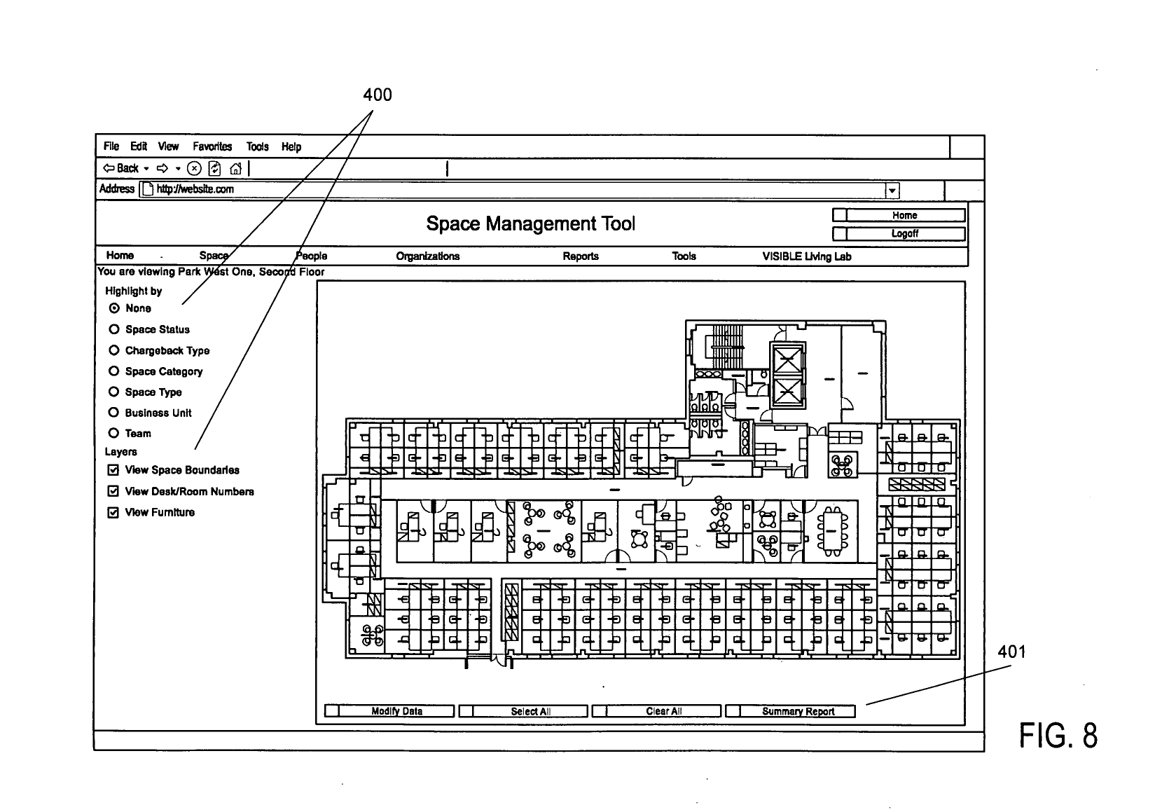

FIG. 8 shows a graphical display of the space management system interface shown in FIG. 7 after a user has selected “space” on the toolbar. The left side of the page contains menu 400. Menu 400 provides the user with options with different ways to highlight the space (e.g., floor plan) shown on the right side of the page. For example, using menu 400, one can view the space by space status, chargeback type, space category, space type, business unit (division), and team (department). One can also view the space in layers, for example, view space with boundaries (of the spaces equipped with an identifier), view space with desk and room numbers and view space with furniture.

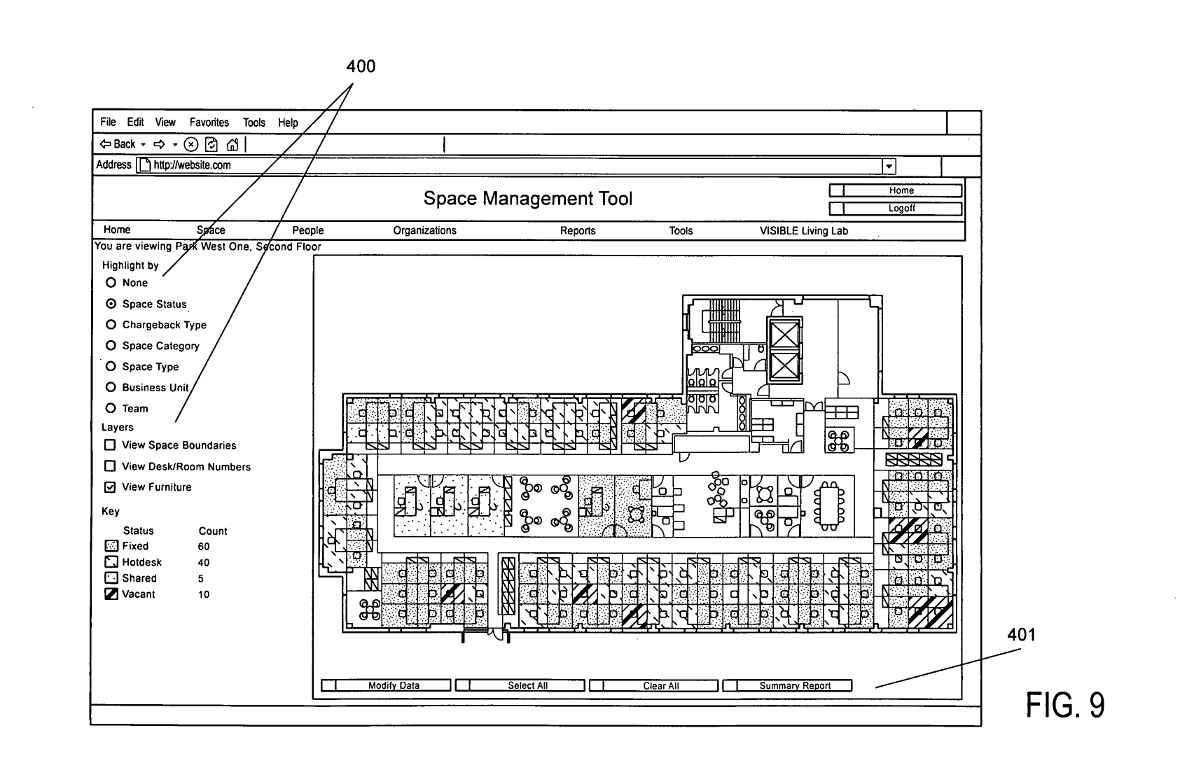

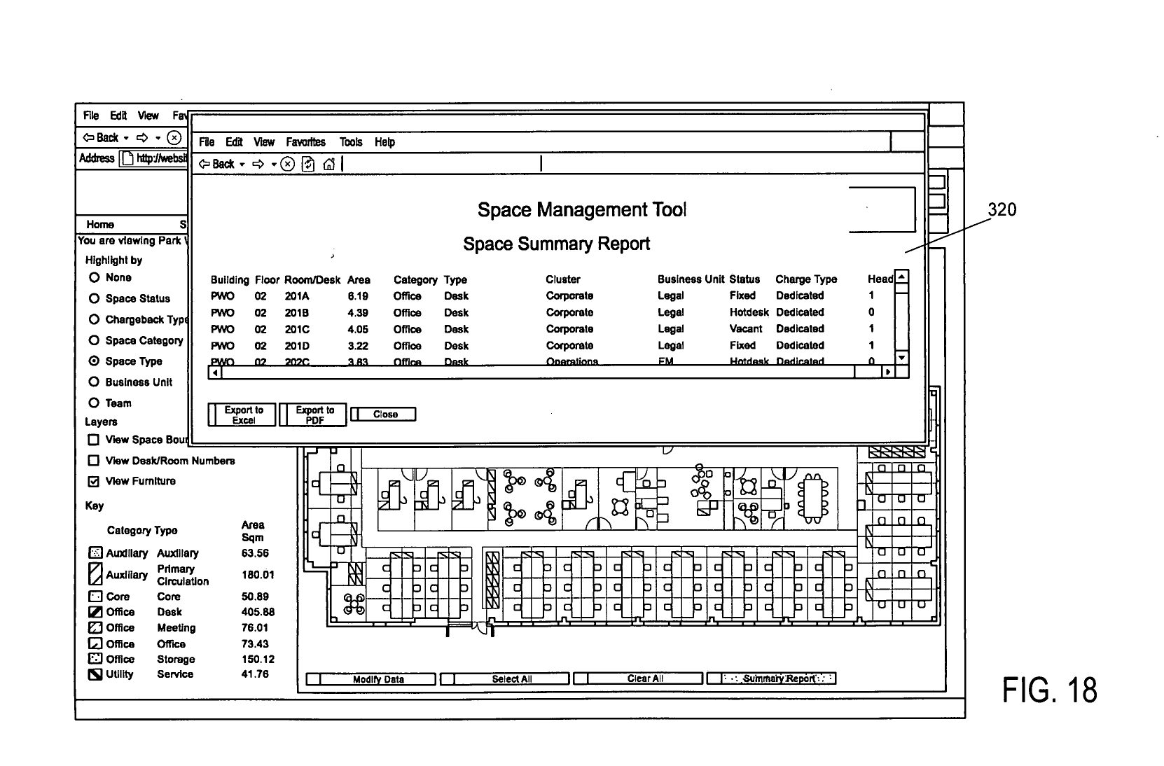

FIG. 9 shows a graphical display of the interface of FIG. 8, after the user has selected the “space status” and “view furniture” options from menu 400. Space status provides a division of space by status, such as fixed space, hot-desk space, shared space and vacant space, with each type shown as a different color on the right side of the interface that shows the space. One can select commands 401, such as: 1) select space (by clicking on it—multiple selections are allowed) and/or select “modify data,” and/or select “summary report”, 2) select “select all” and/or modify all, and/or select “summary report” (refer to FIG. 18), and 3) select “clear all.” The interface shown in FIG. 9 is refreshed based on information input by the user about the new allocation of space, and any changes are reflected on the space view (e.g., floor plan) shown on the interface. A summary report can be obtained for all spaces (such as selecting “select all” and then “summary report”), or for a subset of the spaces.

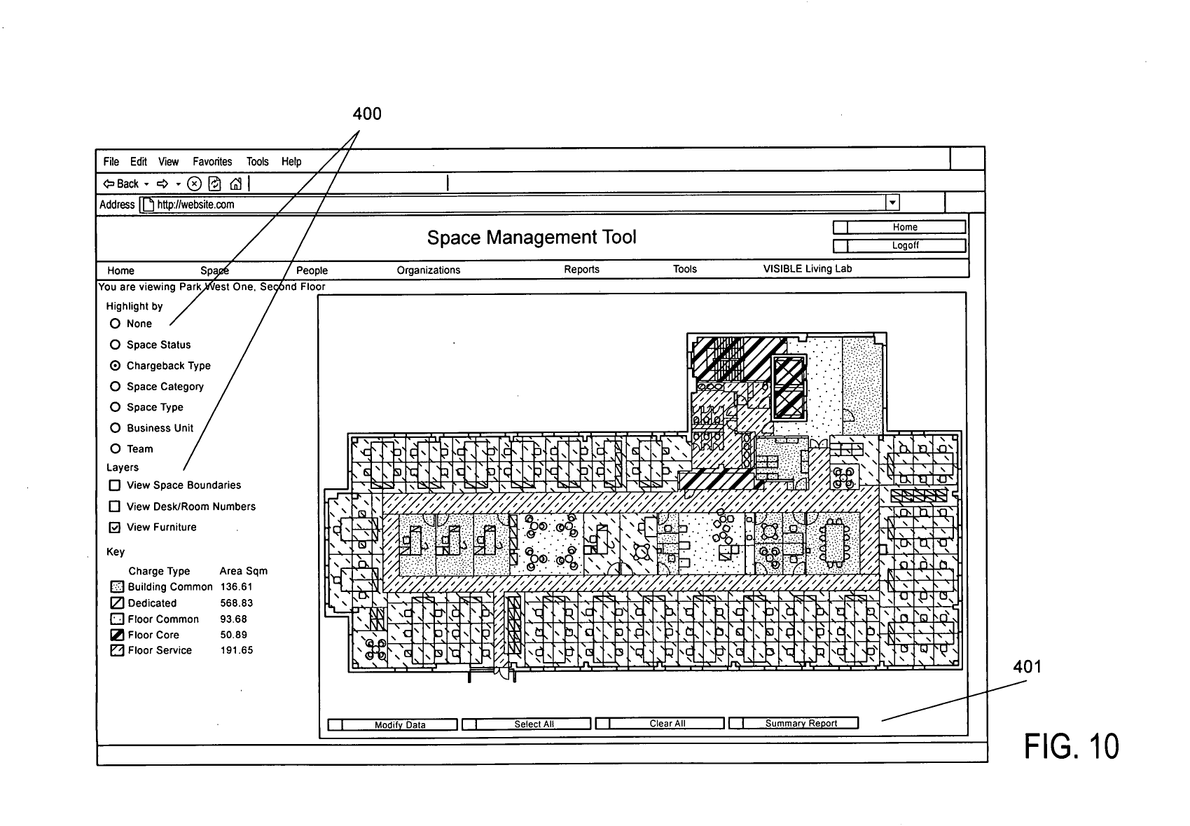

FIG. 10 shows a graphical display of the interface of FIG. 8, after the user has selected the “chargeback type” and “view furniture” options from menu 400. Chargeback type provides a division of space dedicated by type, category, team or business unit, such as building common space, dedicated space, floor common space, floor core space and floor service space. The different spaces are shown as areas in square meters (or any other unit used to convey size information) on the left side of the space management system interface, and a different color is provided for each of the different chargeback categories on the floor plan shown on the right side of FIG. 10. This data can be used to calculate the cost per area (e.g., square meter) or per head or per team or per business unit for the chargeback types. One can select commands 401, such as: 1) select space (by clicking on it—multiple selection are allowed) and/or select “modify data”, and/or select “summary report,” 2) select “select all” and/or modify all, and/or select “summary report” (refer to FIG. 18), and 3) select “clear all”, using the commands provided beneath the floor plan. The interface shown in FIG. 10 is refreshed based on information input by the user about the new allocation of space, and any changes are reflected on the floor plan shown on the interface (when refreshed). In FIG. 10, information is provided on the bottom left of the interface with respect to the area allocated to each of the chargeback types.

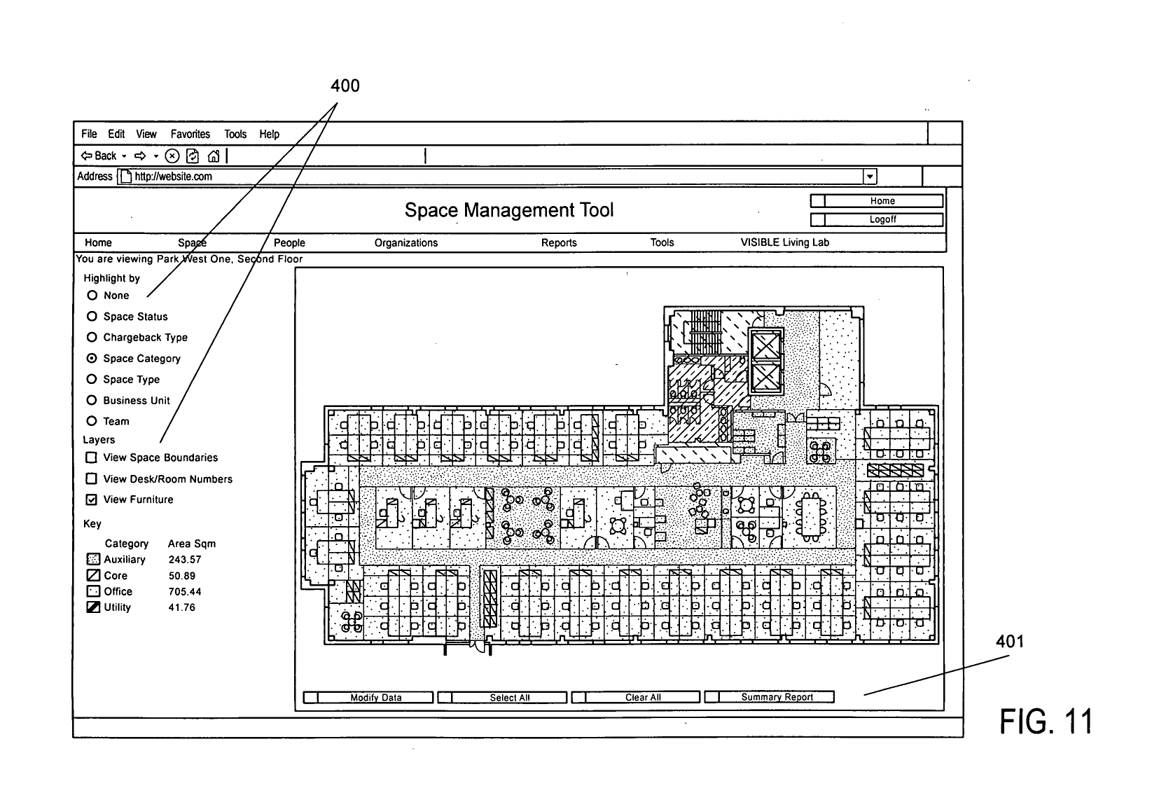

FIG. 11 shows the interface of FIG. 8, after the user has selected “space category” and “view furniture” options from menu 400. Space category provides a division of space by category, and may include, for example, auxiliary space, core space, office space and utility space. This data can be used to calculate the cost per area (e.g., square meter) per space category. One can select commands 401, such as: 1) select space (by clicking on it—multiple selection are allowed) and/or select “modify data,” and/or select “summary report”; 2) select “select all” and/or modify all, and/or select “summary report” (refer to FIG. 18); and 3) select “clear all,” using the commands provided beneath the floor plan. The interface shown in FIG. 11 is refreshed based on information input by the user about the new allocation of space, and any changes are reflected on the floor plan shown on the interface. In FIG. 11, information is provided on the bottom left of that page with respect to the area allocated to each of the space categories.

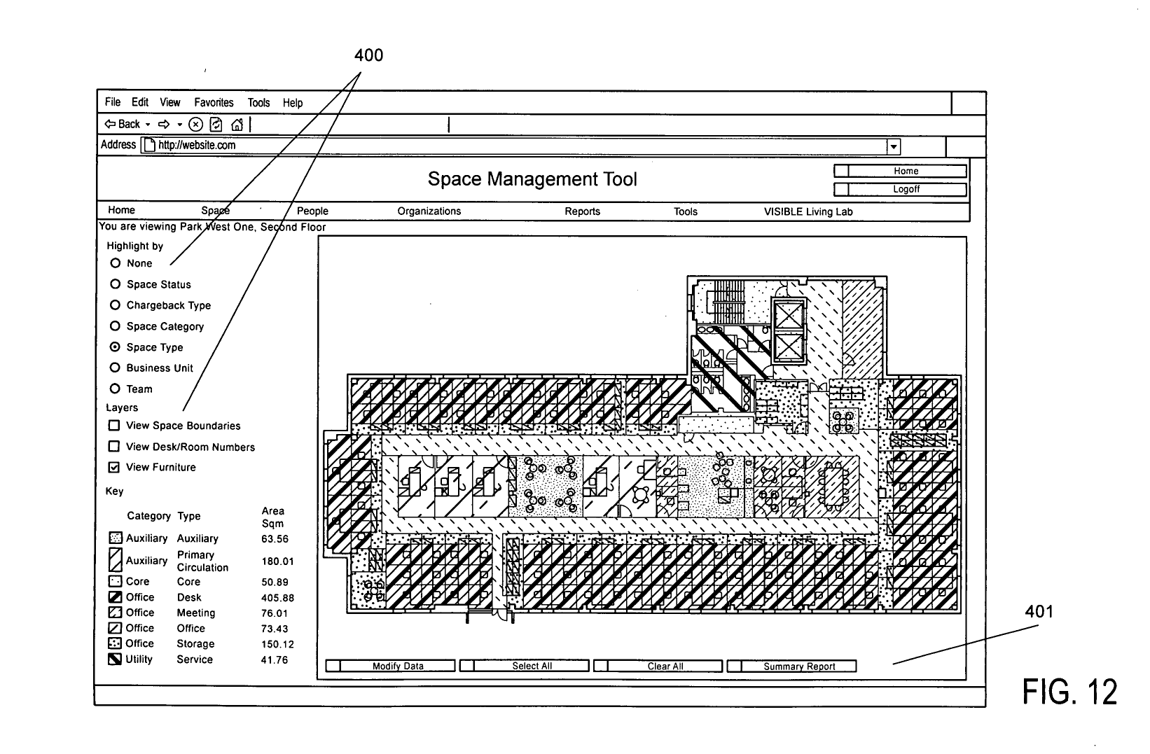

FIG. 12 shows the interface of FIG. 8, after the user has selected “space type” and “view furniture” options from menu 400. The space type selection provides a division by category and type that may include, for example, auxiliary/auxiliary, auxiliary/primary circulation, core/core, office/desk, office/meeting, office/office, office/storage and utility/service. One can select commands 401, such as: 1) select space (by clicking on it—multiple selection are allowed) and/or select “modify data,” and/or select “summary report”; 2) select “select all” and/or modify all, and/or select “summary report” (refer to FIG. 18); and 3) select “clear all,” using the commands provided beneath the floor plan. The interface shown in FIG. 12 is refreshed based on information input by the user about the new allocation of space, and any changes are reflected on the floor plan shown on the interface. In FIG. 12, information is provided on the bottom left of the interface with respect to the area allocated to each of the space types.

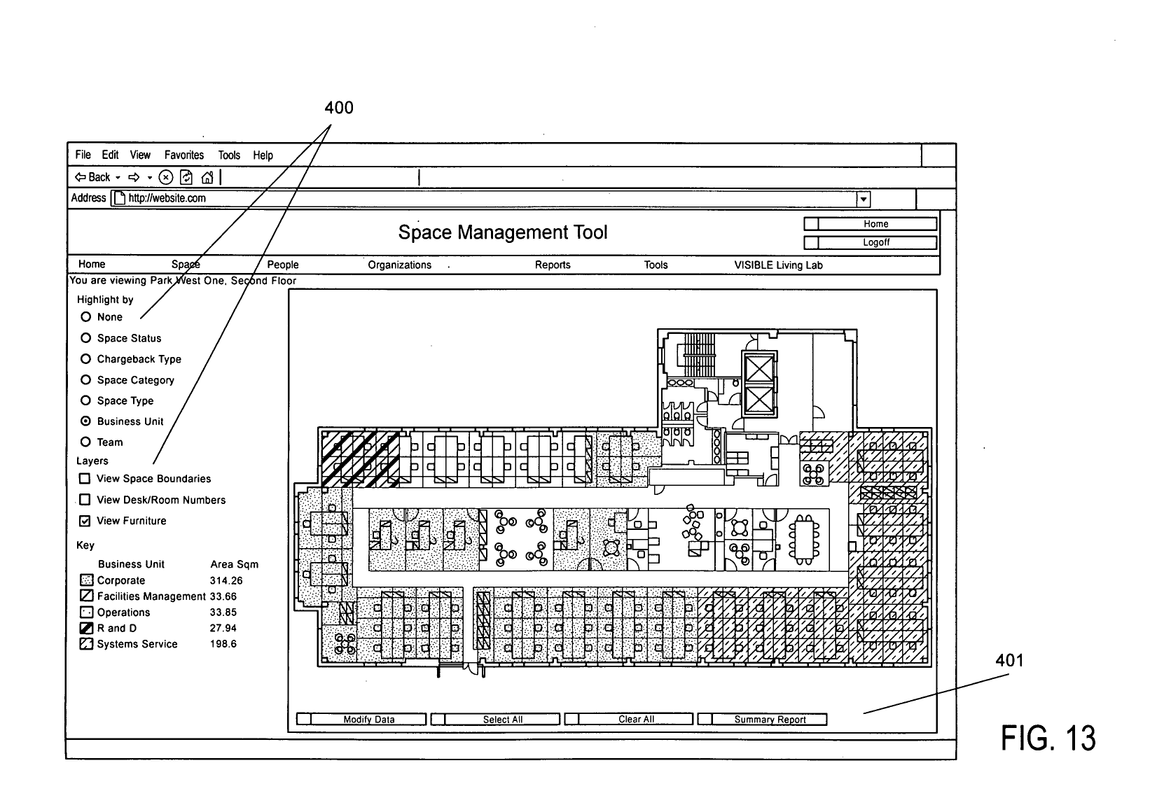

FIG. 13 shows a graphical display of the interface of FIG. 8, after the user has selected “business unit” and “view furniture” options from menu 400. The division selection provides a breakdown of space by division, as defined beforehand by the user, by the system or by someone having sufficient privileges to do so. Space may be broken down into various units, for example, a corporate unit, a facilities management unit, an operations unit, a research and development unit or a systems service unit. One can select commands 401, such as: 1) select space (by clicking on it—multiple selection are allowed) and select “modify data,” and select “summary report”; 2) select “select all” and modify all, and select “summary report” (refer to FIG. 18); and 3) select “clear all,” using the commands provided beneath the floor plan. The interface shown in FIG. 13 is refreshed based on information input by the user, and any changes are reflected on the floor plan shown on the interface. In FIG. 13, information is provided on the bottom left of the interface with respect to the area allocated to each of the different divisions.

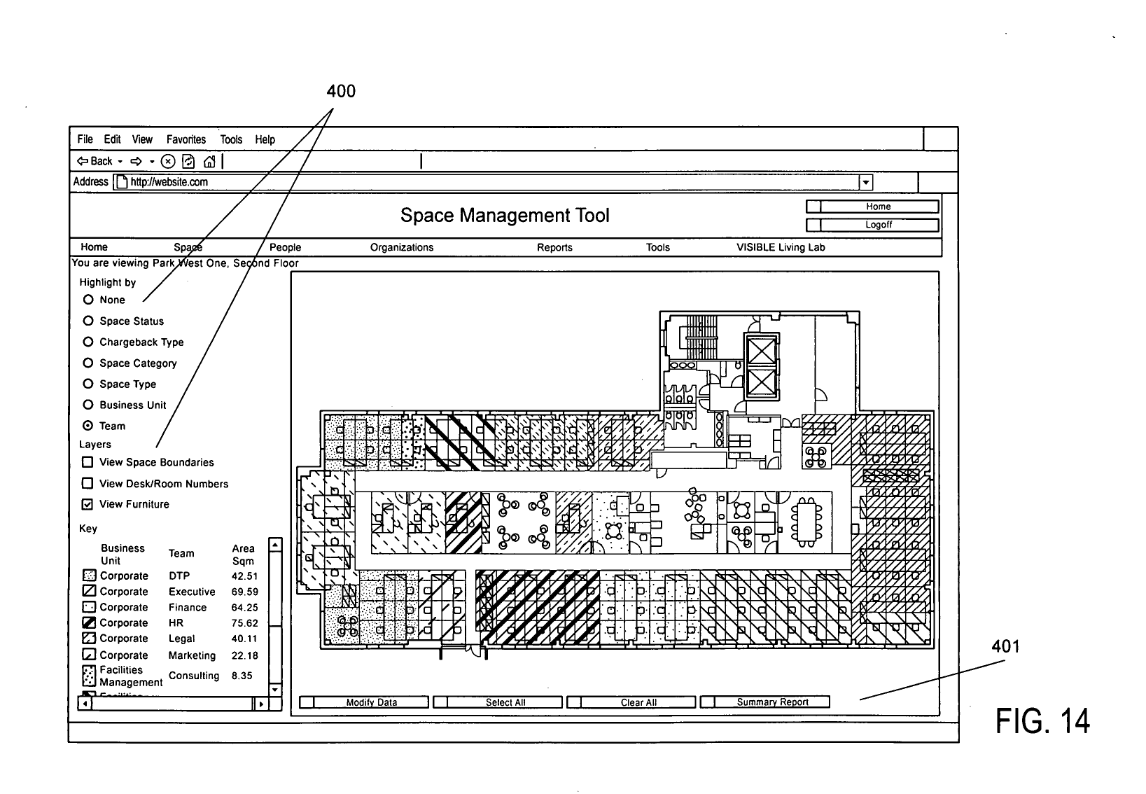

FIG. 14 shows the interface of FIG. 8, after the user has selected “team” and “view furniture” options from menu 400. Space may be broken down for various teams, for example an executive team for the corporate unit, a finance team for the corporate unit, etc. One can select commands 401, such as: 1) select space (by clicking on it—multiple selection are allowed) and/or select “modify data,” and/or select “summary report”; 2) select “select all” and/or modify all, and/or select “summary report” (refer to FIG. 18); and 3) select “clear all,” using the commands provided beneath the floor plan. The interface shown in FIG. 14 is refreshed based on information provided by user, and any changes are reflected on the floor plan shown on the interface. In FIG. 14, information is provided on the bottom left of the interface with respect to the area allocated to each of the different departments.

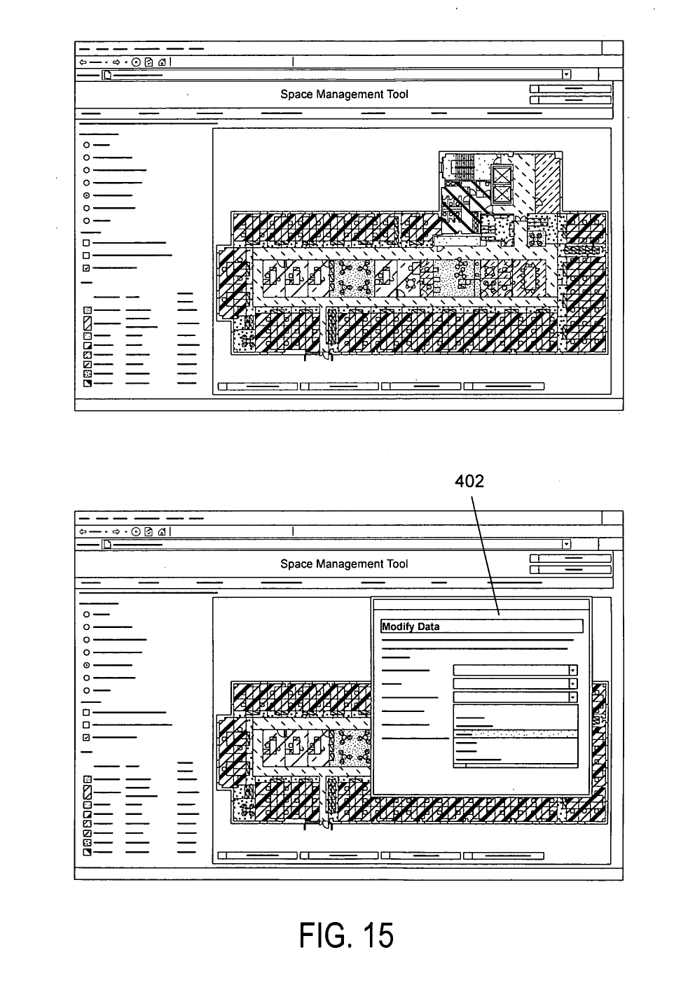

FIG. 15 shows the interface of FIG. 8, with “space type” selected and with “modify data” selected. A user can select a space on the floor plan with the computer mouse (see space selected in black on the screen) and click “modify space”, whereby this command allows a modification of the allocation of the space. Depending on the configuration of the space management system, modification may be propagated through the system and/or to other systems in a rapid manner (e.g. direct and live). Hierarchical data modification is allowed by way of entries made in the pop-up window 402 or otherwise. A user can also perform automatic color allocation of data, whereby the system automatically modifies the data and modifies the view with a new color allocation of the current data. One can select commands 401, such as: 1) select space (by clicking on it—multiple selection are allowed) and/or select “modify data,” and/or select “summary report”; 2) select “select all” and/or modify all, and/or select “summary report” (refer to FIG. 18); and 3) select “clear all,” using the commands provided beneath the floor plan.

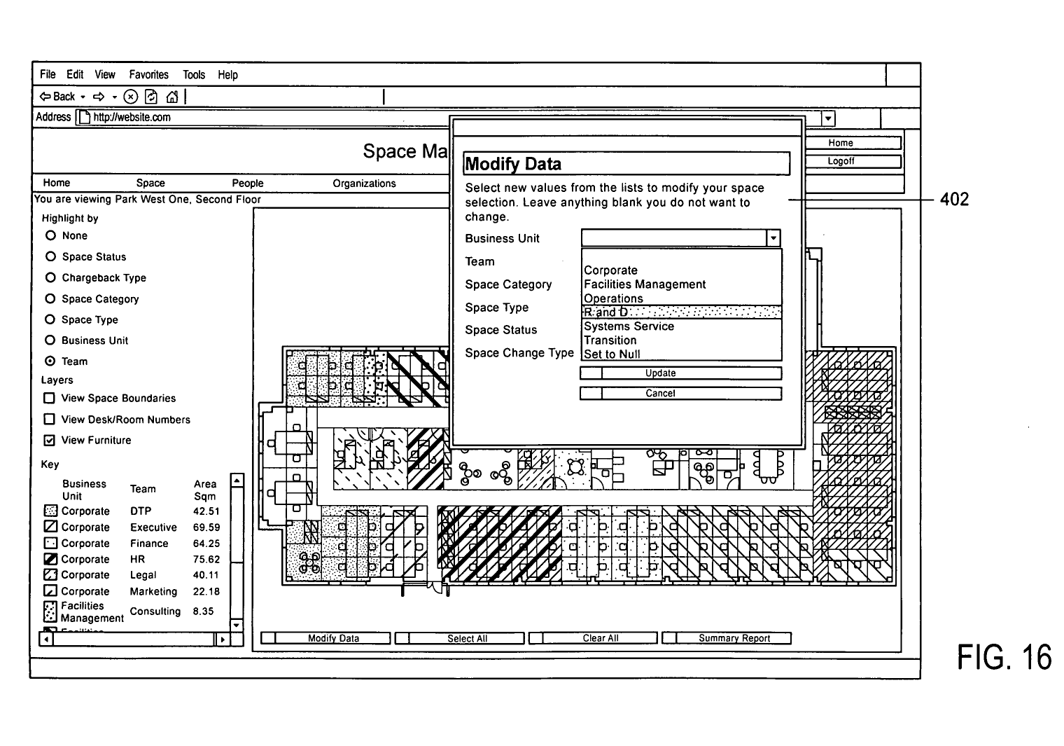

FIG. 16 shows a graphical display of the interface of FIG. 15, in which a pop-up window 402 appears based on the user having selected “modify data.” Hierarchical data modification is allowed by way of entries made in the pop-up window, such as by organization, space or category. For example, a user may select a particular space or space by clicking that space on the floor plan with the mouse, and then by clicking “modify data.” As such, and by way of the pop-up window that appears on the display, the user is allowed to make direct and live modifications of the allocations of space on the floor plan.

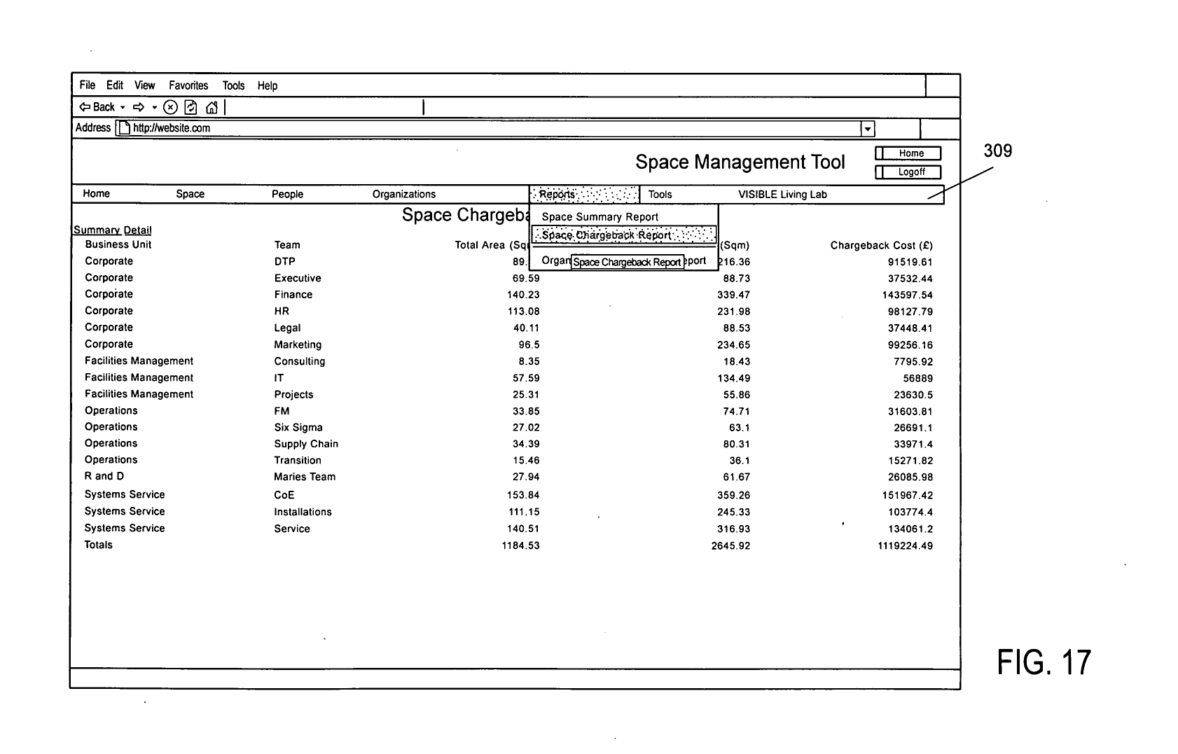

FIG. 17 shows an interface displaying summary information and/or reporting information, after the user has selected the command “reports” in toolbar 309 and has selected the “space chargeback report”. The charge back report will be dynamically updated in accordance to changes to the allocation of space as described in FIGS. 10 to 16. Information provided by the report may be altered based on the preferences of the user.

FIG. 18 shows the interface of FIG. 15, after the user has selected “summary reports” while in the “space type” mode. The user can select all or select one or more spaces with the mouse. The user can click on “summary reports” on toolbar 309 and access instant reporting 320, whereby the user can print the report, and/or export the report to another application (such as Microsoft EXCEL), and/or convert it to a PDF, and/or close the summary reports popup window. See the various selection options provided on the summary reports popup window.

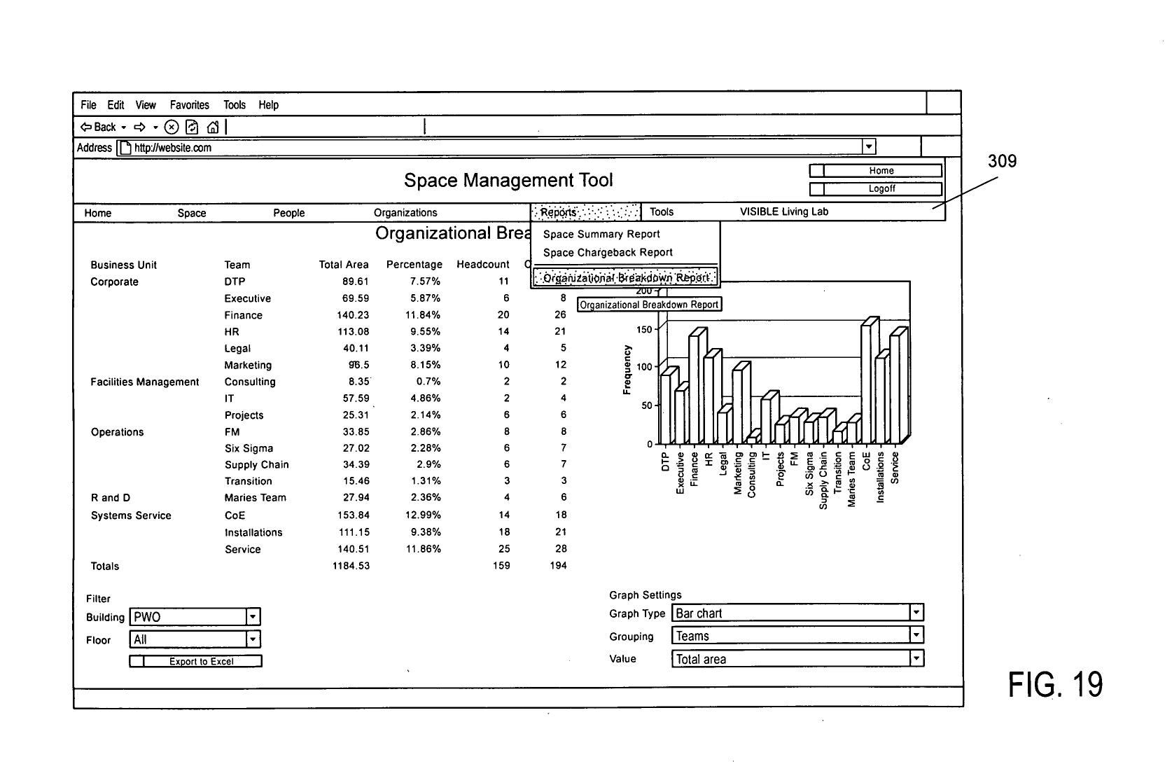

FIG. 19 shows an organizational breakdown report that can be obtained via toolbar 309 by way of a space management system of an exemplary embodiment. The organization breakdown report may include report grouping information (e.g., dynamic or not) and charts displaying the grouping. The user can: 1) extract instant reporting and status on space, 2) filter the information by building and floors, 3) modify and choose graph setting and grouping, 4) show the results by value (e.g., total area, headcount, or capacity), and 5) export the report to another application.

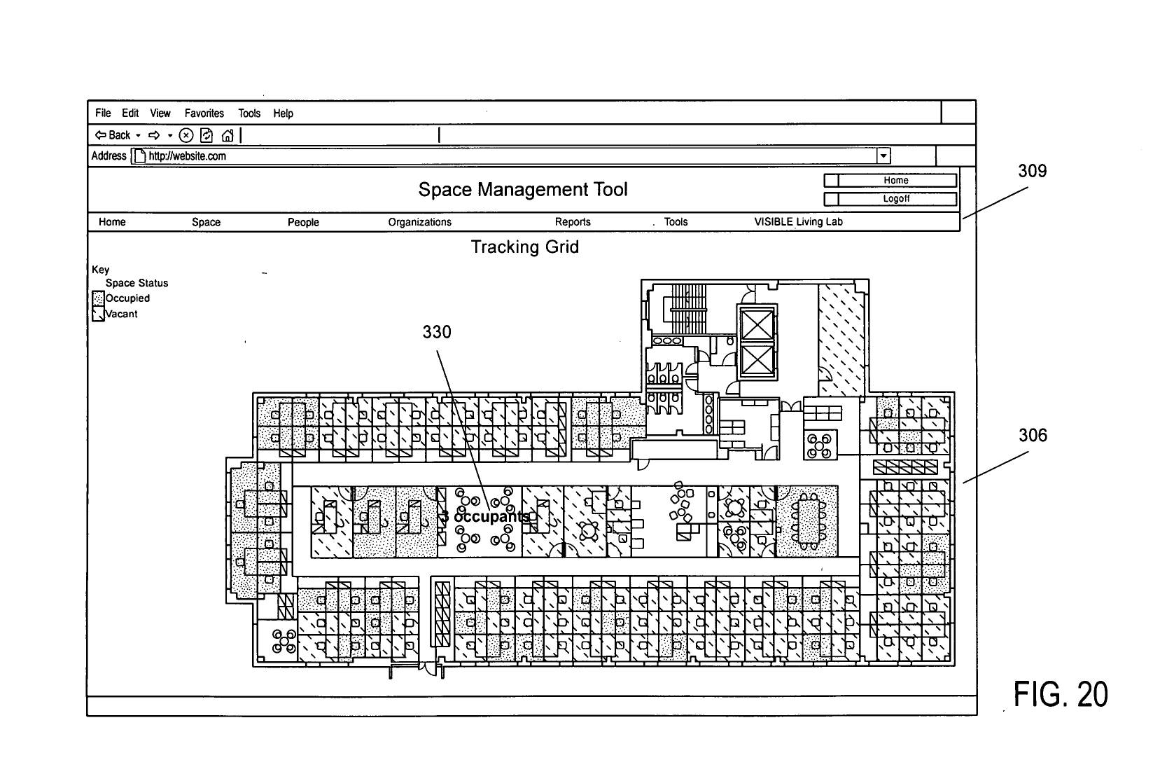

Referring to FIG. 20, as discussed above, a space management system may include a tracking module, a user interface, or a tracking grid that provides information (real-time, recent, near-live, etc.) as to persons in the various spaces of a building at certain times. The tracking grid may shows the numbers of persons in each of the spaces (occupancy data transferred from the identifiers), and the user can obtain graphical and visual output of the data. FIG. 20 shows tracking grid 306 that shows that three occupants are in space 330. Occupancy information may always overlay spaces or occupancy information may appear when a space has been selected by the user (or when the user places his or her mouse pointer over the space). “Occupied spaces” may be shown having a different color than “vacant” spaces (e.g. occupied spaces may be represented by a red color and vacant spaces may be represented by a yellow color). This distinction may allow a user to select or mouse-over those spaces with occupants quickly. Tracking grid 306 may be obtained by clicking on “Visible Living Lab” or otherwise on toolbar 309, according to some exemplary embodiments. Spaces where no identifiers (e.g., RFID readers) are positioned and no recordings or other indication of occupancy are picked up may be represented by a different third color (e.g. white, blue, etc.).

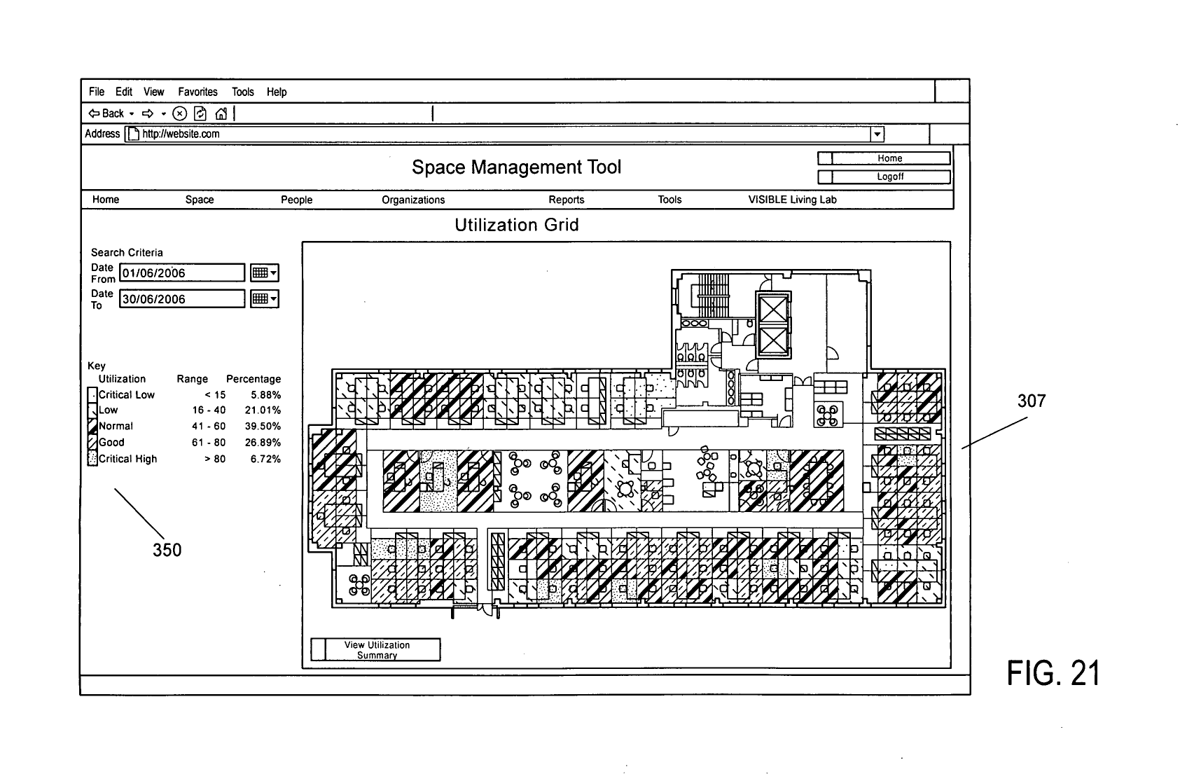

FIG. 21 shows utilization grid 307, which may be a user interface provided by a space management system, according to an exemplary embodiment. Utilization grid 307 may be an interactive information display and/or a reporting tool with filtering functionalities. The user can select a search criteria (i.e., filter) by “date from” to “date to”. The tracking grid may show the average utilization via a color code as shown in “key” region 350. For example, the keys shown in region 350 are for critical low utilization of a space, low utilization of a space, normal utilization of a space, good utilization of a space and critical high utilization of a space. Percentage utilization and the range high and low values are also provided as data on the utilization grid display.

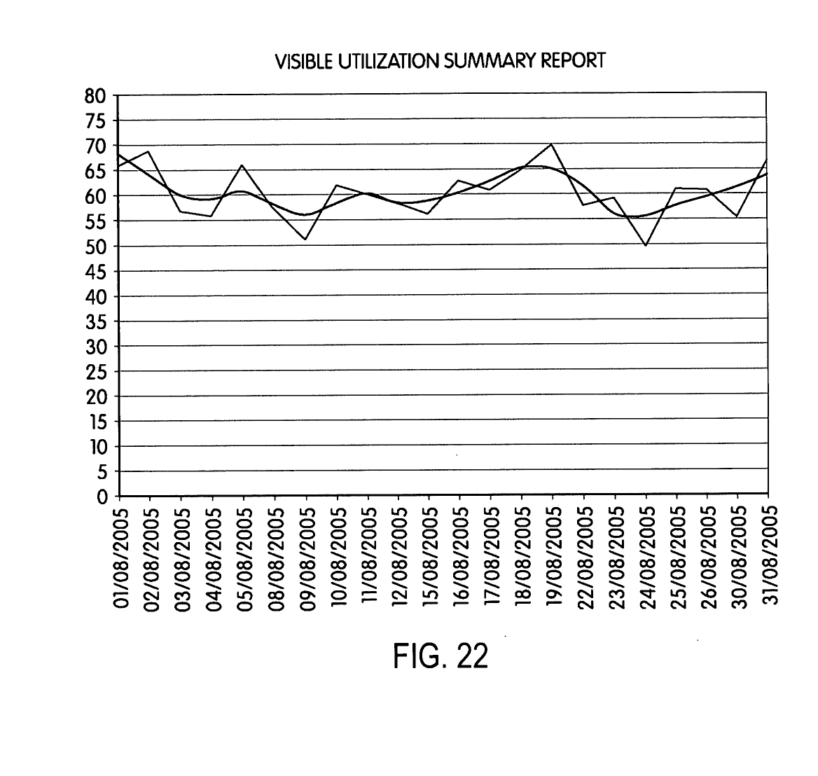

FIG. 22 shows a visible utilization summary report that can be obtained by the user, in which utilization over a particular time period can be summarized or shown (e.g., daily values for a one month period). The average utilization values, as well as the high and low values for a period, may be shown as separate plots on the visible utilization summary report. The reports could be provided and/or generated by or in separate software modules, routines, or packages (e.g. a Cognos®, sold by Cognos, Inc.).

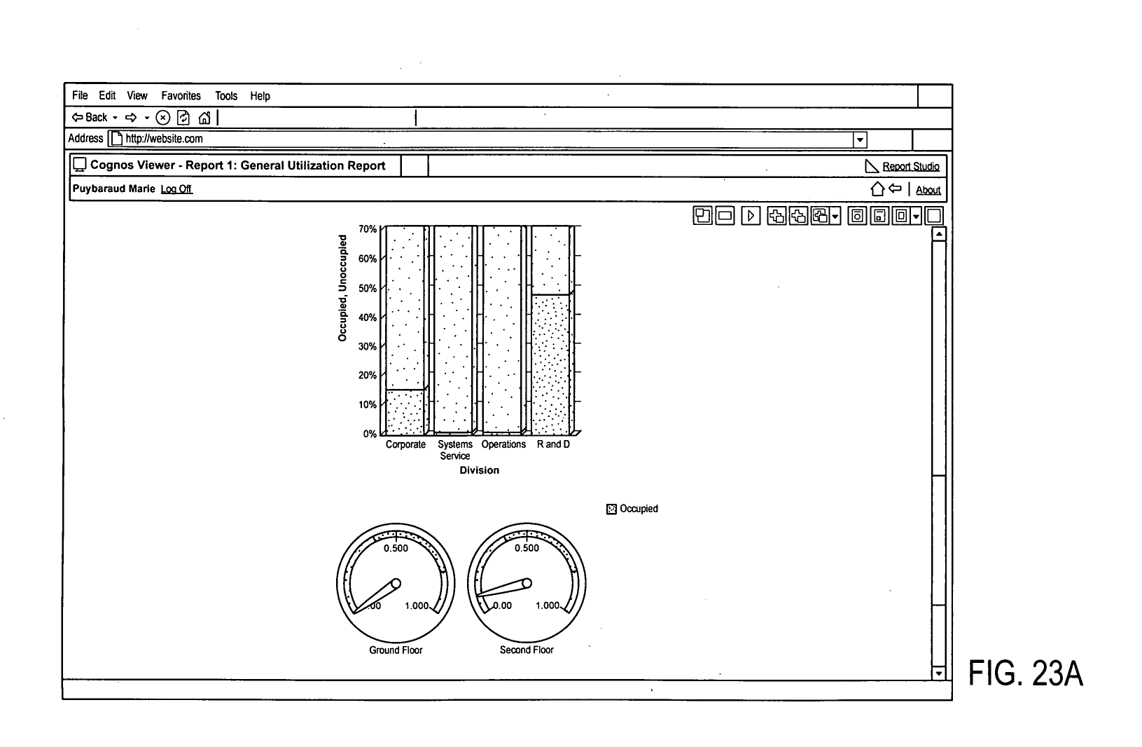

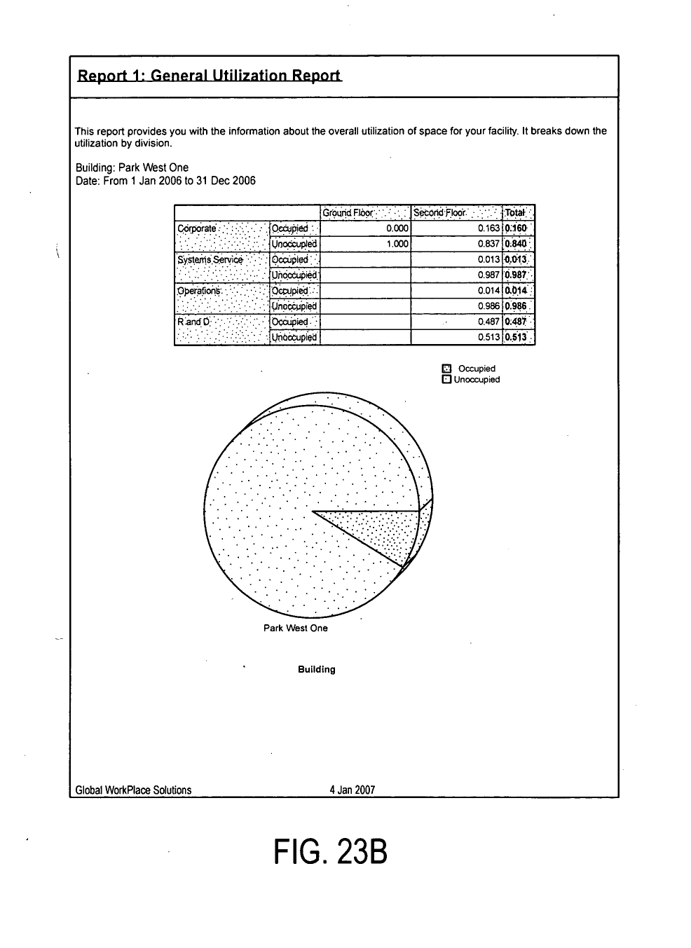

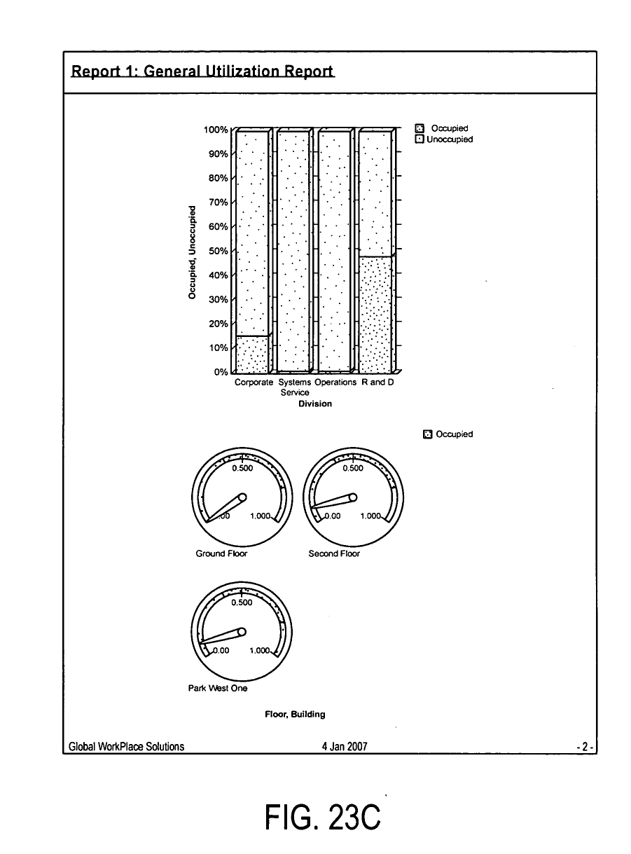

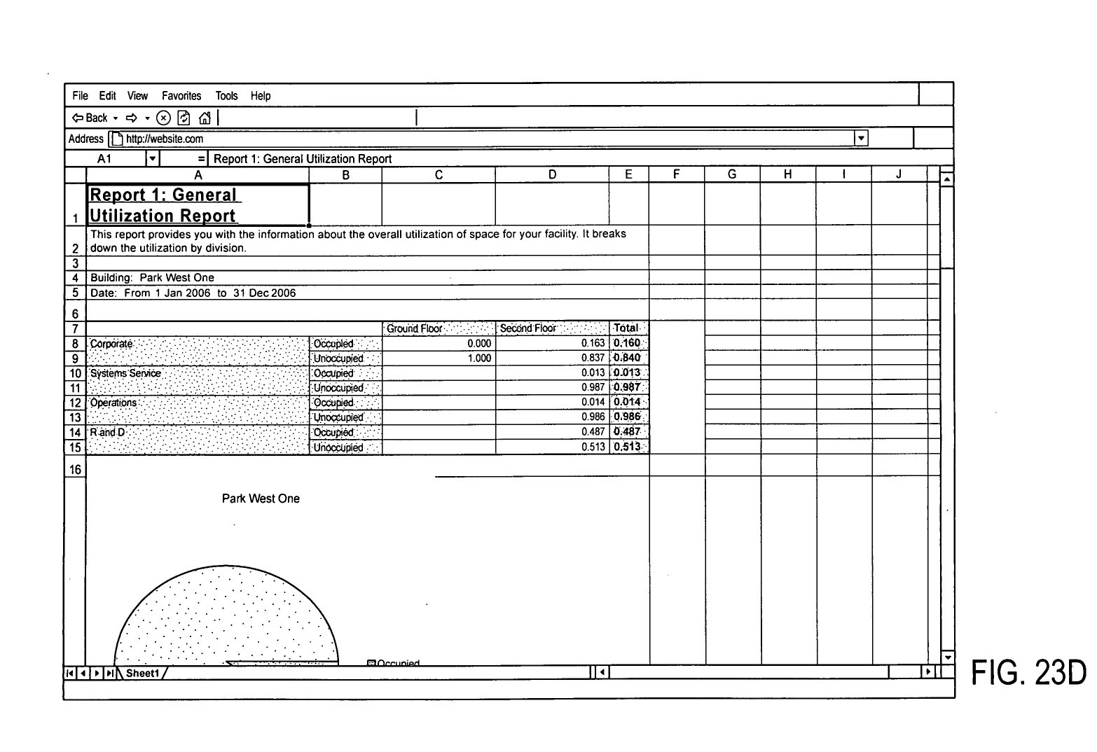

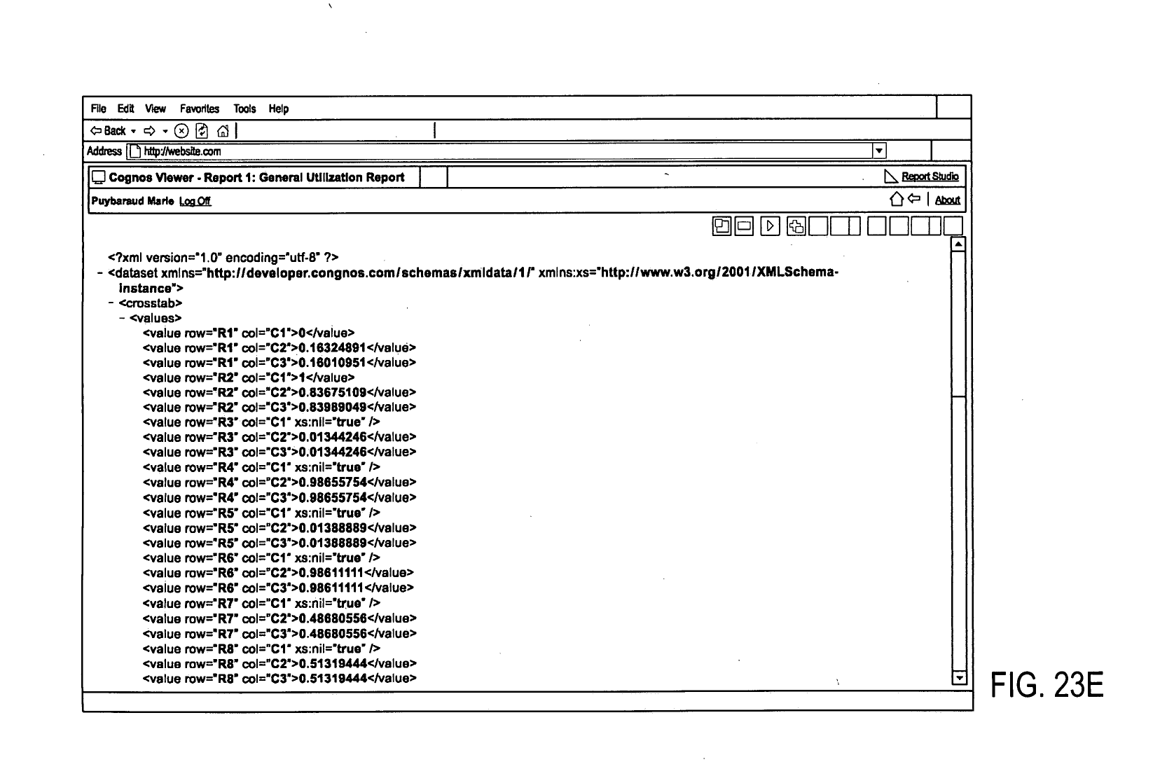

FIGS. 23A through 23E show various examples of different report formats that may be generated by the space management system and/or a data analysis unit of a space management system. For example, referring to FIG. 23A, a report may be produced in a PDF format to be viewed in a computer application (e.g., Adobe Acrobat). Alternatively, referring to FIGS. 23B and 23C, reports may be produced in a HTML format. The reports generated in HTML format may be viewed as a web page by a user on a network, and may be viewed onsite or offsite.

Referring to FIG. 23D, reports may also be generated in a spreadsheet format (e.g., XLS). Using a spreadsheet format, the user may view data in spreadsheet software (e.g. Microsoft EXCEL). Alternatively, referring to FIG. 23E, reports may be generated in an extensible markup language (e.g., XML) format or another markup language. The user may use a XML format to prepare a web page or another application or report that uses the relevant data. It should be apparent to those skilled in the art that reports may be produced in a variety of formats for a variety of computer software and applications.

FIGS. 24A through 24D show various screenshots of reporting interfaces that may be generated by the space management system, according to an exemplary embodiment. Referring to FIG. 24A, the interface displays a number of available reports that may be selected for viewing. The user may select a report to view or a user with administration privileges can select a report to edit or delete. Now referring to FIG. 24B, once a report is selected, the user may be prompted to select options to configure the information provided in the report (or to configure the query used by the data analysis unit to generate the report). For example, the user may select a specific building, specific space or group of spaces in a building, a date or a date range, and/or any number of additional criteria. The screen may provide options as to the type of report produced. Now referring to FIG. 24C, once the selections have been made, the user may be prompted by the screen showing that the report is compiling. Now referring to FIG. 24D, the screen displays the generated report or user interface. The information may be displayed in a number of formats, as described and shown in FIGS. 23A through 23E.

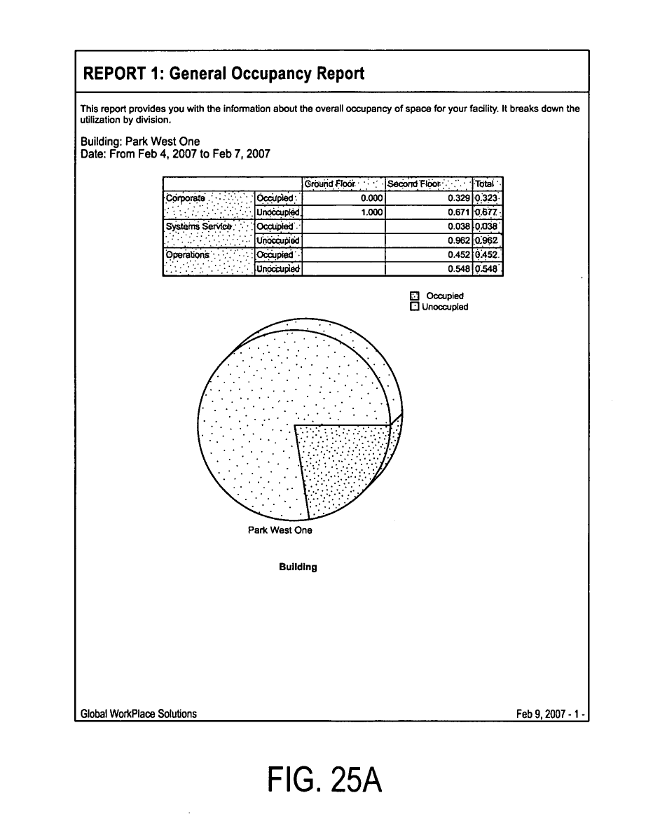

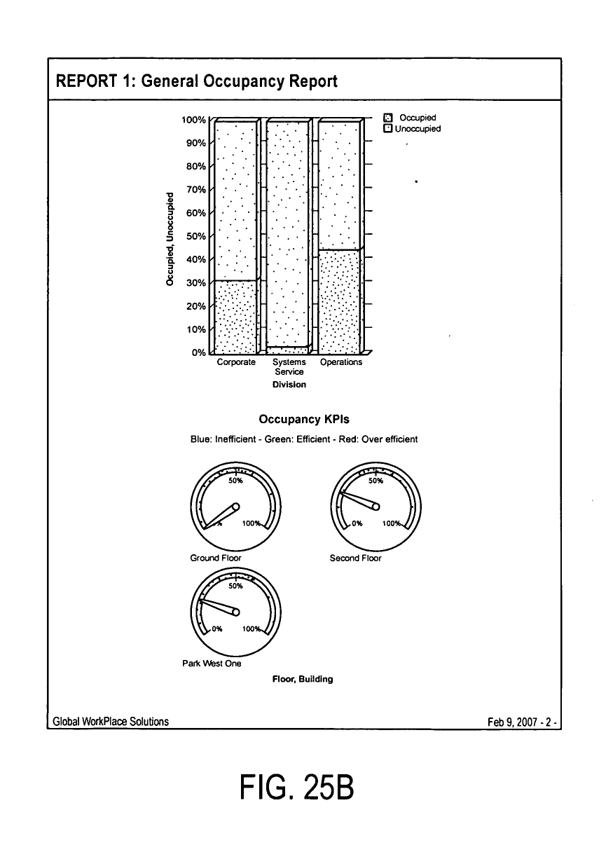

Referring now to FIGS. 25A and 25B, a general occupancy report may be provided, according to an exemplary embodiment. Information produced by a report may be configured in a number of ways. For example, referring to FIG. 25A, the general occupancy report may display a chart or a pie graph. Referring to FIG. 25B, the general occupancy report may display a bar graph or gauges. The formats used to display the data may be chosen by the user or set by an administrator, and may be adjusted.

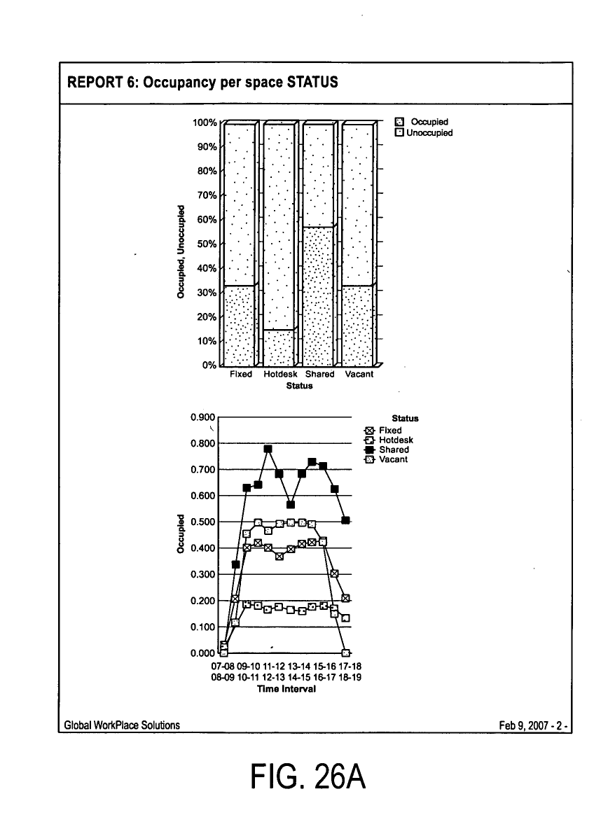

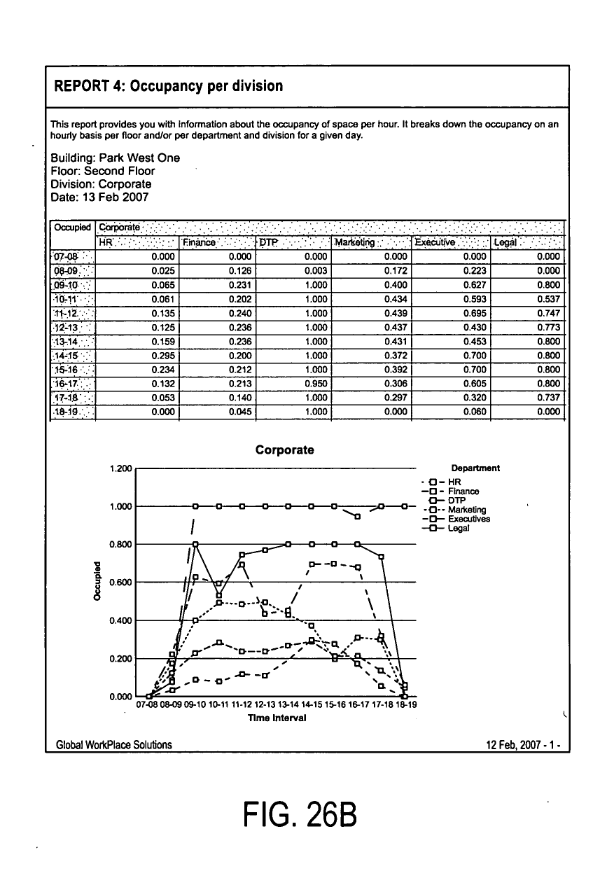

FIGS. 26A and 26B show more examples of reports that may be generated for the user. The user may choose to view data regarding a single space or may choose to view and compare data from various spaces in order to most efficiently manage space. Referring to FIG. 26A, a bar graph or line graph may be used as a comparative tool for these means. Referring to FIG. 26B, a table may be used as a comparative tool, and may break down the data in numerous ways to provide the data that the user needs to manage the space in the workplace properly.

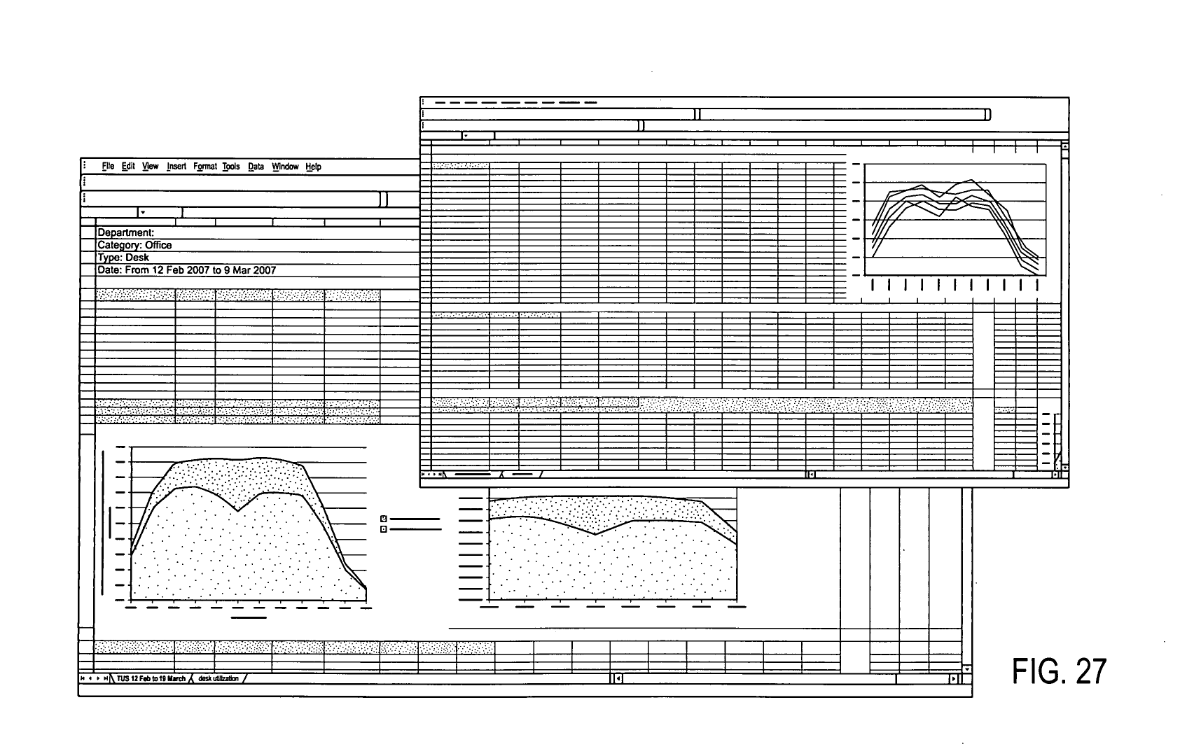

FIG. 27 shows reports in a spreadsheet format generated from the reporting tools generated by the space management system, according to an exemplary embodiment.

The various reports may be generated in a read-only format (the user may not edit information) or may be generated in a format that allows the user to edit information. Using a format that allows for user edits, the user may sort data provided by the report in a number of ways, may edit data provided by the report, or may save the data in a number of formats, as allowed by the computer software package used. It should be apparent to those skilled in the art that the data provided by the reports may be organized and edited in various ways to meet the needs of the user.

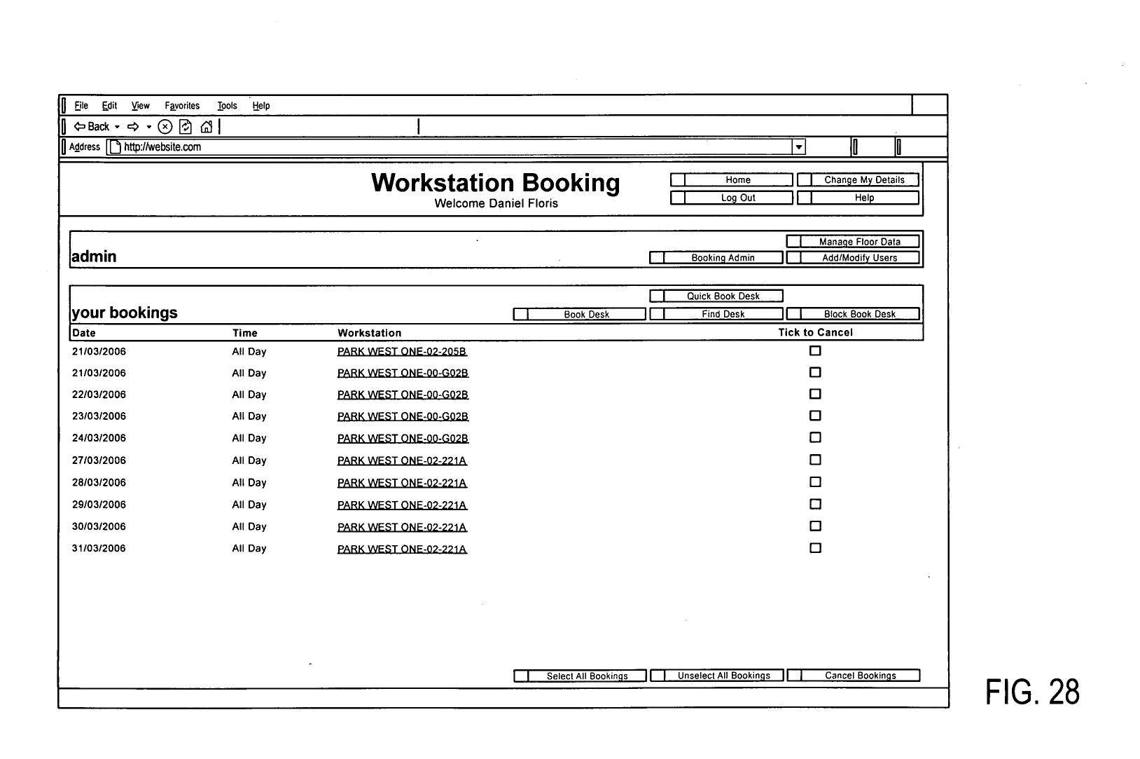

As discussed earlier, another feature/component of a space management system, according to an exemplary embodiment, is a booking tool. A booking tool can allow spaces (e.g., workstations) to be shared according to demand and booked in advance on-line. A booking tool can also be used to monitor space usage and support demand/execution of an appropriate workplace strategy and may be web-based. FIG. 28 shows an interface of a booking tool according to, according to an exemplary embodiment. The interface shown in FIG. 28 may be the interface that is provided on after the user has selected “tools” (on toolbar 309 previously shown) or otherwise activated the booking tool. The booking tool can be used to book a space (e.g., desk), find a space, book a block of spaces for a team, perform quick booking functionalities that allow a user to book a space previously booked, and/or administrate the booking tool (e.g., for persons having sufficient privileges). As shown in FIG. 28, previous bookings made by the user may be shown in a tabular form, with date of booking, time of booking, and space (e.g., workstation) name shown. Other display forms and/or data relating to booking spaces may be shown. The user can select any of those previous bookings to cancel one or more of them.

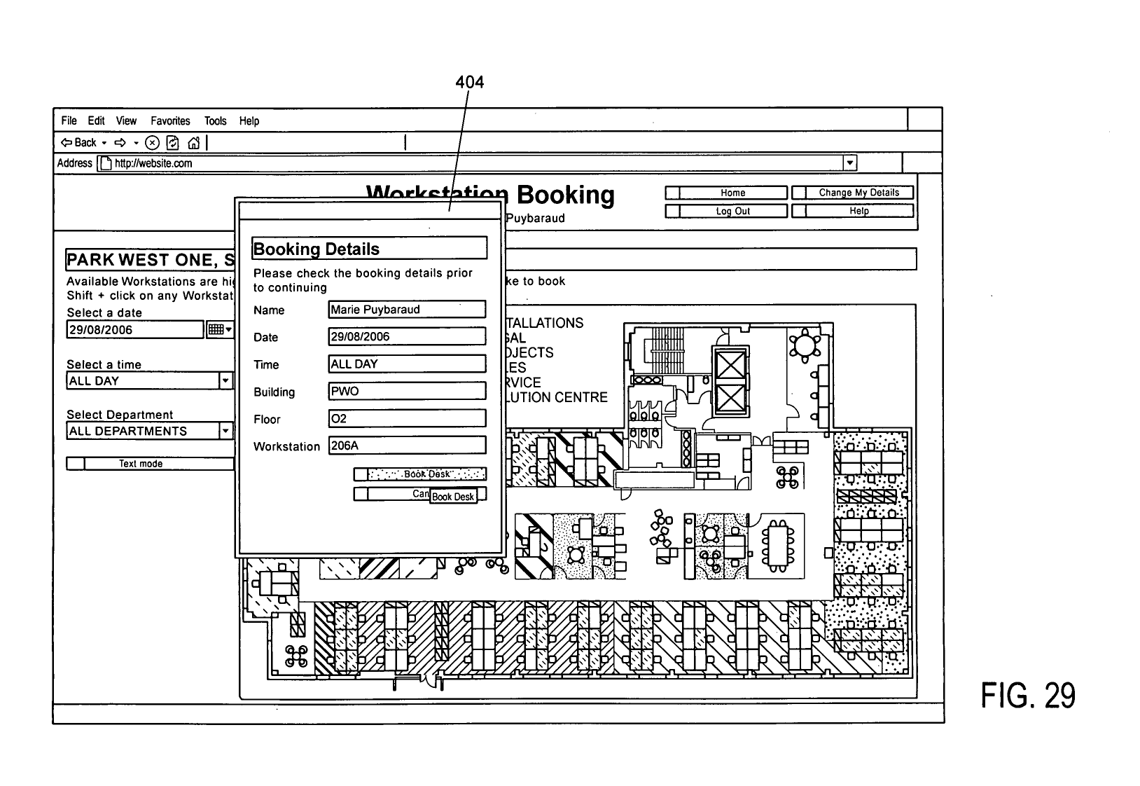

FIG. 29 shows another interface of a booking tool of a space management system, according to an exemplary embodiment. The interface of a booking tool may display a floor plan (e.g., floor map, space grid, etc.) that includes a plurality of spaces (e.g., workstations). A user can click on a space shown on the floor plan and obtain booking information 404 on the space. Additionally, the user may select a date, a time (e.g., one time of a particular day, the entire day, a group of consecutive hours in a day, etc.), a building, a department, a floor and/or any other criteria and then instruct the booking tool to find which spaces meet those criteria (or some of the criteria). The booking tool may query one or more databases and generate a new floor plan (or an overlay for a floor plan) highlighting the spaces that meet the criteria (e.g., highlighted spaces may be shown having a different shading, having a particular color (or shown blinking) on the floor plan). The user can also click on any spaces that is not currently booked (booking status may be shown by way of a particular color or shading on the floor plan), and book the spaces. As shown in FIG. 29, a date, a time (e.g., one time of a particular day, the entire day, a group of consecutive hours in a day, etc.), a building, a floor, and a floor plan is shown on the right side, whereby the user can then click on any workstation to check its booking details. If the workstation is available, the user can click “book desk” in order to book the space for a desired time period.

According to one aspect, there is provided a space management system (i.e., space utilization system). The space management system keeps a record of the space categorization and space ownership of each unit of space or spaces (e.g., workstation, room, utility space, service space, etc.) and enables the user to visualize these spaces or spaces, make changes rapidly, and to generate reports rapidly. The space management system includes a plurality of identification devices (e.g., RFID cards, Smart cards, etc.) respectively provided for a plurality of persons. The system also includes a plurality of identifiers respectively provided in a plurality of spaces, each of the plurality of identifiers capable of reading information output by the plurality of identification devices to indicate presence of a respective identification device in a respective space. The system further includes a data collection unit configured to collect information output at a frequency (i.e. every second, minute, hour, etc.) by the plurality of identifiers and/or identification devices. The system also includes a data analysis unit configured to process the information collected by the data collection unit and to provide the collected information in a graphical form to a user.

According to another aspect, there is provided a space utilization method. The space utilization method includes providing a plurality of identification devices for a plurality of persons. The method also includes providing a plurality of identifiers in a plurality of spaces, respectively, each of the plurality of identifiers capable of reading information output by the plurality of identification devices to indicate presence of a respective identification device in a respective space. The method further includes collecting information output by the plurality of identifiers indicative which of the plurality of identification devices have been identified as being located in the plurality of spaces which the plurality of identifiers are respectively provided. The method also includes analyzing the information collected by the collecting step and providing the collected information in a graphical form to a user.

According to yet another aspect, there is provided a web-based computer program product embodied in computer readable medium and executable by a computer, the computer program product, when executed, causing the computer to perform the steps of: collecting information output by the plurality of identifiers indicative which of the plurality of identification devices have been identified as being located in the plurality of spaces which the plurality of identifiers are respectively provided; and analyzing the information collected by the collecting step and providing the collected information in a graphical form to a user.

According to still yet another aspect, there is provided a booking system, which includes a database that stores information regarding a plurality of spaces (workspaces, spaces, workstations, rooms, cubicles, offices, conference rooms, etc.) that are capable of being booked for use. The booking system also includes a graphical user interface that provides a user with a capability to book one or more of the plurality of spaces based on a desired date, desired date range, and/or time of day of use. The booking system further includes or is coupled to an analysis unit that obtains the user-inputted information provided to the graphical user interface and that queries the database to determine if the one or more of the plurality of spaces that meet the query criteria are available to be booked, and that provides the user with an indication of booking availability or unavailability.

According to yet another aspect, an analysis component (e.g., data analysis unit 210) of a space management system may include a variety of rules to determine the status of a space for a period of time based on the occupancy data collected by the data collection unit. For example, three states could be determined by the analysis component: “occupied,” “appears to be occupied,” and “unoccupied”. A space could be determined to be unoccupied if no identification device was identified to be present in the space during the period of time (e.g., one day, one hour, etc.). A space could be determined to be occupied when an identification device is identified to be present in the space during the period of time. A space could be determined to be “appears to be occupied” if a space was occupied for part of the period of time but unoccupied for another part of the period of time. According to another exemplary embodiment, a space could be determined to be “appears to be occupied” if the zone was occupied, then unoccupied, then occupied again during the same period of time (e.g., by the same or a different identification device). An “occupied” status may begin from the time (e.g., minute, second, etc.) a zone is occupied. The time before a zone is occupied may be defined as unoccupied. These or other states, rules, or status definitions could be used to build the occupancy data and/or to transform or analyze the occupancy data of database 211. A measure or determination of utilization may depend on the above-mentioned rules. For example, utilization time might be calculated as time “occupied” plus time “appeared to be occupied” during a period of time. Utilization percentage might be calculated by dividing utilization time by the total period of time. Additional or alternative rules, methods, and/or calculations may be used by the space management system to generate the user interfaces and/or reports of the system, according to various exemplary embodiments.

According to yet another aspect, spare capacity may be calculated by the system using a method including the step of defining a target utilization. Target utilization may be a maximum determined utilization (e.g., manually determined and input by a user) and/or determined or calculated by applying a benchmark based on a known, calculated, or user-input profile of the space (e.g., taking into account space aspects such as size of the space, space type, ventilation capability of the space, etc.). Once a target utilization is defined for the space, spare capacity for the space may then be calculated by subtracting the actual utilization from the target utilization. For example, if a target utilization defined to be 80% and actual utilization is determined to be 50%, spare capacity would be 30%. Additional or alternative steps or calculations may be used to determine spare capacity, according to various exemplary embodiments.

Various exemplary embodiments of the space management system have the capability of integrating with software and/or hardware of security systems (access control, digital video surveillance systems), building management systems, hospitality management systems, and/or room booking systems.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments. The present application contemplates methods, systems and program products on any machine-readable media for accomplishing its operations. The embodiments of the present application may be implemented using an existing computer processors, or by a special purpose computer processor for an appropriate system, incorporated for this or another purpose or by a hardwired system.

It is important to note that the construction and arrangement of the elements or steps of the space management system and/or the various reports or user interfaces as shown in the various exemplary embodiments is illustrative only. Although only a few embodiments have been described in detail in this disclosure, those skilled in the art who review this disclosure will readily appreciate that many modifications are possible (e.g., variations in sizes, dimensions, connections, systems, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

As noted above, embodiments within the scope of the present application include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps.

What is claimed is:

1. A space management system for analyzing the utilization of a space by one or more persons, the space management system comprising:
a data collector configured to collect information provided by one or more identifiers distributed in the space, the information indicating a presence of the one or more persons in the space, the data collector configured to store occupancy data for the space based on the collected information; and
a data analyzer coupled to the data collector, the data analyzer configured to generate a graphical user interface for providing to an electronic display, the graphical user interface based on the occupancy data and comprising at least one of:
a) an indication of a percentage of time the space was occupied during a period of time, and
b) a graphical indicator based on the percentage of time the space was occupied during the period of time and the number of persons present in the space during the period of time.

2. The space management system of claim 1, wherein the data collector is configured to store more than one record indicating a presence of the one or more persons in the space per hour and the data analyzer is configured to utilize the more than one record to generate the graphical user interface.

3. The space management system of claim 1, wherein the space comprises a plurality of sub-spaces and wherein an identifier is provided for each sub-space and the information collected by the data collector includes an indication of the sub-space relating to the information.

4. The space management system of claim 3, wherein the data analyzer is further configured to cause a current occupancy state of the space to be displayed with the graphical user interface, the displayed current occupancy state of the space comprising an indication of a current occupancy state for the plurality of sub-spaces.

5. The space management system of claim 3, wherein the indication of the percentage of time the space was occupied during the period of time includes an indication of the percentage of time a sub-space was occupied during the period of time.

6. The space management system of claim 5, wherein the current occupancy state of the space is graphically represented on the graphical user interface as a tracking grid showing the indication of the current occupancy state, wherein the tracking grid is a graphical representation of a floor plan for the space.

7. The space management system of claim 6, wherein the indication of the percentage of time the space was occupied during the period of time is shown on the tracking grid, and wherein the tracking grid includes graphical representations of the sub-spaces, and wherein the indication of the percentage of time each sub-space was occupied during the period of time is shown with the sub-spaces on the tracking grid.

8. The space management system of claim 1, wherein the identifiers are devices configured to communicate via radio frequency signals to determine the presence of one or more identification devices.

9. The space management system of claim 8, wherein the identification devices are portable electronic devices carried by the people in the space.

10. The space management system of claim 9, wherein each identification device comprises at least one of an RFID circuit and a Zigbee transceiver.

11. The space management system of claim 9, wherein each identification device is self-powered and an active device that is configured to report to the identifiers without first requiring a radio frequency reception from the identifiers.

12. A method for facilitating the management of a plurality of spaces having a plurality of identifiers configured to receive information provided by a plurality of identification devices, the information relating to the presence of a respective identification device in a respective space, the space management method comprising:
collecting the information at a data collector;
storing the information in memory associated with the data collector as occupancy data; and
using a data analyzer to analyze the occupancy data and to generate a graphical user interface for display on an electronic display, the graphical user interface comprising the results of the analysis;
wherein the graphical user interface is based on the occupancy data and comprises at least one of:
a) an indication of a percentage of time each space was occupied during a period of time, and
b) a graphical indicator of the percentage of time each space was occupied during the period of time and the number of persons present in each space.

13. The method of claim 12, further comprising:
using the data analyzer to cause a map to be displayed on the graphical user interface, the map including a representation of the plurality of spaces and an indication of at least one of occupancy and utilization for the plurality of spaces.

14. The method of claim 12, further comprising:
storing, per hour, more than one record indicating presence of the one or more persons in the space; and
utilizing the more than one record to generate the graphical user interface.

15. The method of claim 12, wherein the space comprises a plurality of sub-spaces and wherein an identifier is provided for each sub-space and the information collected by the data collector includes an indication of the sub-space relating to the information; and wherein the method further comprises:
causing the graphical user interface to display an occupancy state for a plurality of sub-spaces, the graphical user interface comprising a tracking grid corresponding to at least one of a map and a floor plan for the space.

16. The method of claim 15, wherein the indication of the percentage of time the space was occupied during a period of time includes an indication of the percentage of time at least one sub-space was occupied during the period of time.

17. The method of claim 12, wherein the identifiers are radio frequency readers configured to determine the presence of one or more identification devices;
wherein the identification devices are portable electronic devices carried by the people in the space; and
wherein the identification devices comprise at least one of an RFID circuit and a Zigbee transceiver.

18. A server device, comprising:
a data collection unit configured to receive occupancy information from a plurality of identifiers distributed around a building space, the identifiers configured to gather the occupancy information via radio frequency communications with identification devices carried by occupants of the building space; and
a data analysis unit configured to generate a graphical user interface for display on an electronic display, the graphical user interface comprising at least:
(a) a graphical representation of a floor plan for the building space; and
(b) a graphical representation of occupant movement through the floor plan over a period of time.

19. The server device of claim 18, wherein the graphical representation of occupant movement comprises at least one of solid and broken lines representing the movement.

20. The server device of claim 19, wherein the data analysis unit is further configured to provide, via the graphical user interface, a graphical indication of a percentage of time the building space was occupied during the period of time and a number of occupants present in the building space during the period of time.
